(19) United States
(12) Patent Application Publication
(10) Pub. No.: US 2026/0261417 A1
(43) Pub. Date: Sep. 3, 2026

(54) ZERO KNOWLEDGE PROOF BASED CHILD KEY AUTHENTICITY

(71) Applicant: nChain Licensing AG, Zug (CH)

(72) Inventors: Mehmet Sabir KIRAZ, London (GB); Michaella PETTIT, London (GB); Chloe TARTAN, London (GB)

(21) Appl. No.: 18/718,351

(22) PCT Filed: Dec. 6, 2022
(86) PCT No.: PCT/EP2022/084661

§ 371 Date: Jun. 10, 2024

(30) Foreign Application Priority Data
Dec. 17, 2021 (GB) 2118449.4

(51) Int. Cl. H04L 9/32

(52) U.S. Cl. CPC H04L 9/3218; H04L 9/3268

(57) ABSTRACT

In one embodiment of the present disclosure there is provided a computer implemented method of verifying the authenticity of a child public key that is associated with an entity. The method is performed on a computing device and comprises: obtaining the child public key; receiving a zero knowledge proof from a proving computing device; verifying that the zero knowledge proof is valid using the proof, the child public key, and a verification key, to determine that a key derivation protocol has been used to derive the child public key from a parent key; and determining the authenticity of the child public key based on said verifying.

### CROSS REFERENCE TO RELATED APPLICATIONS

This application is the U.S. National Stage of International Application No. PCT/EP2022/084661, filed on Dec. 6, 2022, which claims the benefit of United Kingdom Patent Application No. 2118449.4, filed on Dec. 17, 2021, the contents of which are incorporated herein by reference in their entireties.

### TECHNICAL FIELD

The present disclosure relates to proving and verifying child key authenticity.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain.

It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated.

Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

Hierarchical deterministic (HD) wallets based on the BIP32 key derivation protocol offer a convenient and efficient way to derive many digital keys. BIP32 wallets are inherently lightweight and versatile. This is because users only need to back-up a wallet seed from which all their keys are derived, and different key derivation paths can be defined based on user requirements.

Wallet providers offer additional features that make digital wallets even more user-friendly. One such example is where users can link their identity to the keys in their wallet. Suppose a user has a publicly known BIP32 master key that is linked to their identity. The user (prover) then produces a child key that they give to another user (verifier) to receive a payment. If the child key is unhardened, the verifier can verify the link between the child key and the prover's identity. The trade-off is that the verifier may also determine other unhardened child keys used by the prover in publicly recorded transactions i.e., on-chain. Alternatively, if the child key is hardened, the verifier would need to link the child key directly to the prover's identity, neither case is optimal. An unhardened child key can be derived from a public parent key and an index, whereas a hardened child key can only be derived from a private parent key and an index.

### SUMMARY

According to one aspect disclosed herein, there is provided a computer implemented method of verifying the authenticity of a child public key that is associated with an entity. The method is performed on a computing device and comprises: obtaining the child public key; receiving a zero knowledge proof from a proving computing device (e.g. a proving computing device associated with said entity); verifying that the zero knowledge proof is valid using the proof, the child public key, and a verification key to determine that a key derivation protocol has been used to derive the child public key from a parent key; and determining the authenticity of the child public key based on said verifying.

According to another aspect disclosed herein, there is provided a computer implemented method of providing proof of the authenticity of a child public key that is associated with an entity. The method is performed on a computing device and comprises: generating a zero knowledge proof using a parent key used to derive the child public key, the child public key, and a proving key; and transmitting the zero knowledge proof to a verifying computing device to enable the verifying computing device to prove that a key derivation protocol has been used to derive the child public key from the parent key.

Zero-Knowledge Proofs (ZKPs) are a method by which a party, known as the prover, may prove to another party, known as the verifier, that a statement is true, without revealing any information beside the fact that the statement is true. In embodiments of the present disclosure, a ZKP is generated to provide proof that a key derivation protocol (e.g. the BIP32 key derivation protocol or any other key derivation protocol) has been used to derive the child public key from the parent key without revealing the parent key to the verifier. That is, the term ‘zero-knowledge proof’ is used herein to mean a proof of knowledge between a prover and a verifier for which no information about the sensitive/secret data is revealed.

Embodiments of the present disclosure can be used to secure HD wallets against privilege escalation attacks and preserves the privacy of the prover by hiding the parent key used to derive the child public key.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 is a schematic block diagram of the phases of Groth16-like zkSNARK constructions for a set of inputs and outputs;

FIG. 5 illustrates the BIP32 key derivation protocol;

FIG. 6 illustrates a process for proving and verifying the authenticity of a child public key.

FIG. 7 shows a circuit representing the BIP32 child key derivation function according to an embodiment of the invention which illustrates which inputs and outputs are public and secret in a proof generation and proof verification process;

FIG. 8 shows a circuit representing the BIP32 child key derivation function according to a further embodiment of the invention which illustrates which inputs and outputs are public and secret in a proof generation and proof verification process;

FIG. 9 shows a circuit representing the BIP32 child key derivation function according to another embodiment of the invention which illustrates which inputs and outputs are public and secret in a proof generation and proof verification process;

FIG. 10 shows a circuit representing the BIP32 child key derivation function according to a further embodiment of the invention which illustrates which inputs and outputs are public and secret in a proof generation and proof verification process;

FIGS. 11a and 11b illustrate a process for proving and verifying the authenticity of a child public key; and

FIG. 12 illustrates the data structure of an X.509 digital certificate.

### DETAILED DESCRIPTION OF EMBODIMENTS

### Example System Overview

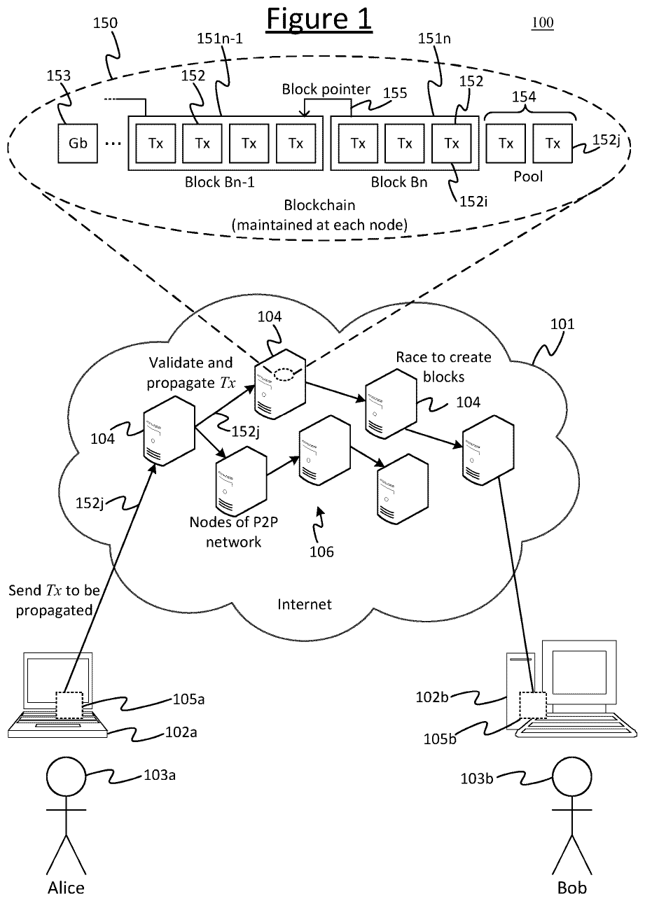

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactortries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104.

A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

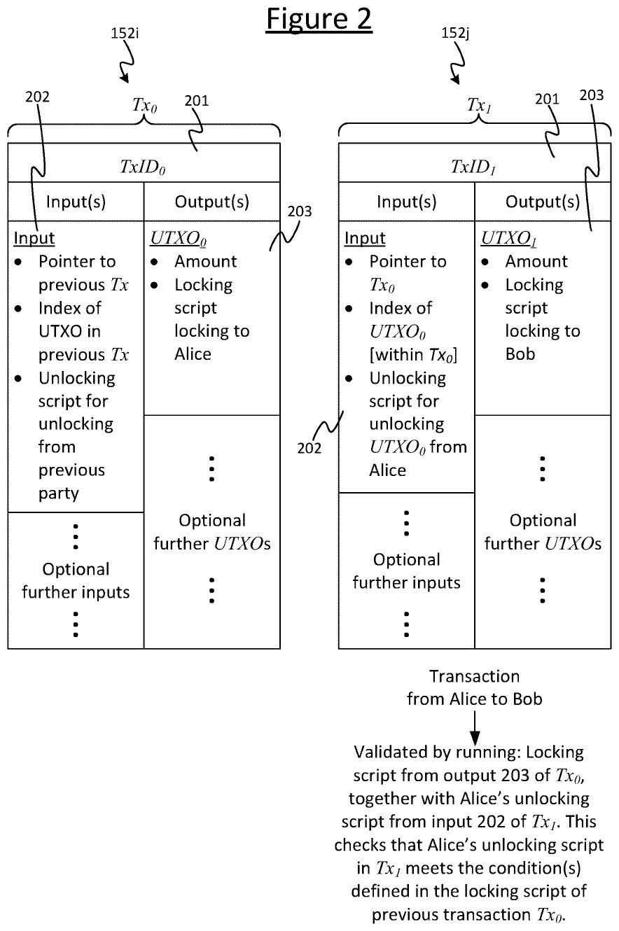

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx1”. It takes an amount of the digital asset that is locked to Alice in the output 203 of a preceding transaction 152i in the sequence, and transfers at least some of this to Bob. The preceding transaction 152i is labelled “Tx0” in FIG. 2. Tx0 and Tx1 are just arbitrary labels. They do not necessarily mean that Tx0 is the first transaction in the blockchain 151, nor that Tx1 is the immediate next transaction in the pool 154. Tx1 could point back to any preceding (i.e. antecedent) transaction that still has an unspent output 203 locked to Alice.

The preceding transaction Tx0 may already have been validated and included in a block 151 of the blockchain 150 at the time when Alice creates her new transaction Tx1, or at least by the time she sends it to the network 106. It may already have been included in one of the blocks 151 at that time, or it may be still waiting in the ordered set 154 in which case it will soon be included in a new block 151. Alternatively Tx0 and Tx1 could be created and sent to the network 106 together, or Tx0 could even be sent after Tx1 if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx0 comprises a particular UTXO, labelled here UTXO0. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO0 in the output 203 of Tx0 comprises a locking script [Checksig PA] which requires a signature Sig PA of Alice in order for UTXO0 to be redeemed (strictly, in order for a subsequent transaction attempting to redeem UTXO0 to be valid). [Checksig PA]contains a representation (i.e. a hash) of the public key PA from a public-private key pair of Alice. The input 202 of Tx1 comprises a pointer pointing back to Tx1(e.g. by means of its transaction ID, TxID0, which in embodiments is the hash of the whole transaction Tx0). The input 202 of Tx1 comprises an index identifying UTXO0 within Tx0, to identify it amongst any other possible outputs of Tx0. The input 202 of Tx1 further comprises an unlocking script <Sig PA>which comprises a cryptographic signature of Alice, created by Alice applying her private key from the key pair to a predefined portion of data (sometimes called the “message” in cryptography).

The data (or “message”) that needs to be signed by Alice to provide a valid signature may be defined by the locking script, or by the node protocol, or by a combination of these.

When the new transaction Tx1 arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:
<Sig PA><PA>∥[Checksig PA]
where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key PA of Alice, as included in the locking script in the output of Tx0, to authenticate that the unlocking script in the input of Tx1 contains the signature of Alice signing the expected portion of data. The expected portion of data itself (the “message”) also needs to be included in order to perform this authentication. In embodiments the signed data comprises the whole of Tx1 (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx1 meets the one or more conditions specified in the locking script of Tx0 (so in the example shown, if Alice's signature is provided in Tx1 and authenticated), then the blockchain node 104 deems Tx1 valid. This means that the blockchain node 104 will add Tx1 to the ordered pool of pending transactions 154. The blockchain node 104 will also forward the transaction Tx1 to one or more other blockchain nodes 104 in the network 106, so that it will be propagated throughout the network 106. Once Tx1 has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx1, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key PA. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### Client Software

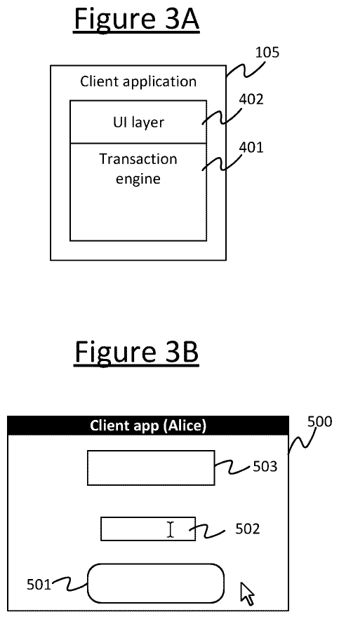

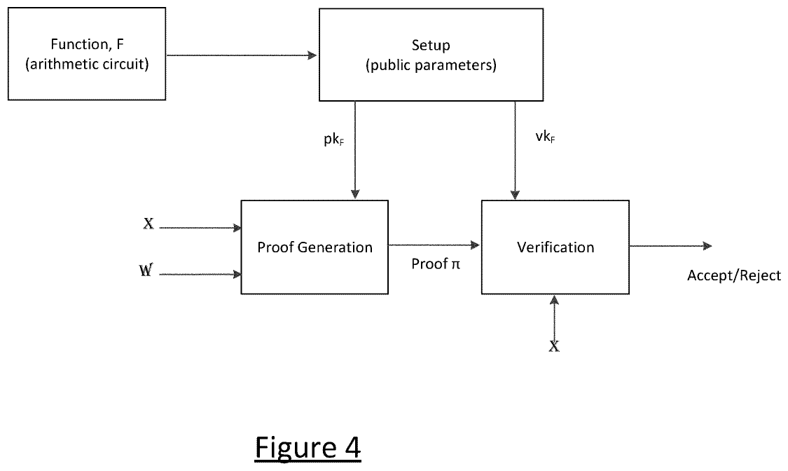

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, send transactions to one or more nodes 104 to be propagated through the blockchain network 106, in accordance with the schemes discussed above and as discussed in further detail shortly.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands). The options enable the user (Alice) to formulate transactions 152 and send transactions to one or more nodes 104 to be propagated through the blockchain network 106

Alternatively or additionally, the UI elements may comprise one or more data entry fields 502, through which the user can formulate transactions 152 and send transactions to one or more nodes 104 to be propagated through the blockchain network 106. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3B is only a schematized mock-up and in practice it may comprise one or more further UI elements, which for conciseness are not illustrated.

### Zero Knowledge Proofs

As noted above, a Zero Knowledge Proof (ZKP) can be used to prove knowledge of a secret without revealing any secret data. Without loss of generality, embodiments of the present disclosure are described with reference to Groth16-like constructions of the zkSNARK protocol to construct simple and efficient ZKPs, however embodiments extend to other ZKPs such as Bulletproof and Plonk.

A zkSNARK (Zero-Knowledge Succinct Non-Interactive Argument of Knowledge) is a Non-Interactive Zero-Knowledge (NIZK) proof of knowledge that is succinct and for which proofs are very short and easy to verify. The statement is represented in terms of logic circuits that is used to generate a proof of the statement. In the most efficient constructions, the verifier simply performs a constant number of group operations. A zkSNARK can be used to prove knowledge of a secret input \vec{w} to an arbitrary function F for a given output. It uses a linear probabilistic proof, combined with zero knowledge techniques based on a bilinear pairing and the Discrete Logarithm Problem (DLP).

An arithmetic circuit C is used to represent the function F for which a ZKP is provided of a secret input given public inputs and outputs. The circuit is constructed from multiplication and addition gates. An output of a multiplication gate that is not an output of the whole circuit is labelled an auxiliary variable.

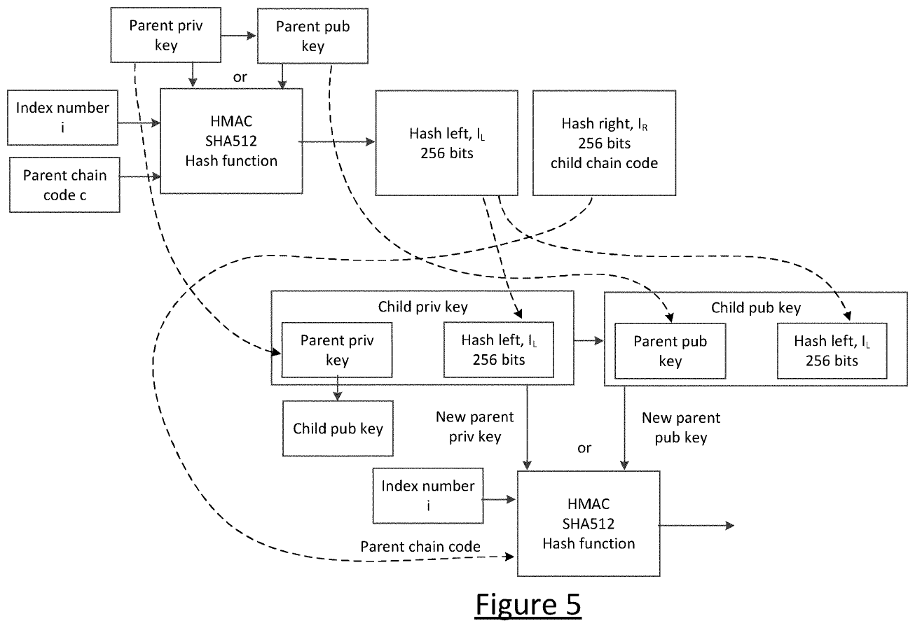

A zkSNARK protocol generally consists of three phases (which are illustrated in FIG. 4):
a. Setup (a trusted third party executes key generation): Given a statement, a proving and verification key pair is computed through several internal steps that include Algebraic circuit generation, R1CS (Rank-1 Constraint System) and QAPs (Quadratic Arithmetic Programs). The private information must be destroyed and never come into existence again as anyone accessing these can create attacks.
b. Proof generation (a prover executes proof generation): Given the public information, proving key, public and private inputs, the prover generates a proof and sends it to the verifier.
c. Verification (a verifier executes a verification protocol): Given public information, the verification key, and public input, the verifier performs verification.

Table 1 shown below shows the Inputs and outputs for each phase of Groth16-like constructions of the zkSNARK protocol.

TABLE 1

| Phase | Inputs | Outputs |
|---|---|---|
| Setup | Circuit C | Proving key pk_{F}, |
| | | Verification key vk_{F} |
| Prover | Proving key pk_{F}, Public | Proof π |
| | input X, Witness W | |
| Verifier | Verification key vk_{F}, Public | Decision bit 1 or 0 |
| | input X, Proof π | |

A zkSNARK protocol should satisfy the following properties:
Completeness: If the statement is true, and the verifier and prover are honest, then the proof is accepted.
Soundness: If the statement is false, a cheating prover cannot convince an honest verifier that it is true except with negligible probability.
Zero-Knowledge: A zero knowledge proof reveals no information to the verifier beside the truth of the statement.
Succinct: The proof is shorter than the circuit size and the verifier must do a lower number of cryptographic operations than the circuit size.
Non-Interactive: The proof is sent to the verifier in one step only.
Arguments of Knowledge: The proof is considered to be computationally sound. Namely, an unbounded prover (like quantum computers) can prove false statements without being detected.
Knowledge: Prover indeed knows the witness and cannot construct the proof without having access to the witness (which is the private input needed to prove the statement), i.e., there is an extractor algorithm that interacts with prover and outputs the witness.

A prover can use a zkSNARK to prove knowledge of a ‘valid assignment’ (X, W), which is a vector comprised of the inputs, outputs and auxiliary variables of the circuit otherwise denoted as:
{inᵢ, outⱼ, auxₖ}

where i,j,k are integers that denote the number of variables for each parameter in the valid assignment. Note that the inputs within the valid assignment inᵢ consists of secret inputs \vec{w} and optional public inputs x. Both the public component [symbol] of the valid assignment (i.e., any public inputs and all outputs of the circuit and any public auxiliary variables) and the secret component W of the valid assignment (i.e., all secret inputs and any secret auxiliary variables) are fed into the proof generator. Note that the verifier only has visibility of the public component [symbol] of the valid assignment. That is, the term “secret” is used herein to refer data that is not known to a verifier. By defining the function F as an arithmetic circuit from which the key generation protocol is enacted in the setup phase of the zkSNARK, the outputs from the setup (i.e., the proving and verification keys) can be used to generate multiple proofs for different valid assignments ( [symbol] , W) of any given circuit. FIG. 4 illustrates the flow of inputs and outputs between each of the three phases.

In FIG. 4, the ‘ [symbol] ’ that is fed into the proof generation process performed by the prover refers to all public parameters in the valid assignment e.g., public inputs ‘x’ to the function F, public outputs from the function F, and any public auxiliary variables. In FIG. 4, the ‘W’ includes all secret parameters in the valid assignment e.g., secret inputs ‘w’ to the function F, and any secret auxiliary variables.

During the second proof generation phase, the prover calculates three polynomials A(z), B(z), C(z), that depend on the circuit and the valid assignment. The set of polynomials form part of a quadratic arithmetic program (QAP), which encodes the constraints of the circuit at different values of z. The prover is asked to prove a constraint is satisfied at an unknown value z=τ. Given this proof, we assume that the prover has knowledge of all the constraints (alluding to the ARgument property of the zkSNARK). A proof π will be accepted provided the QAP divisibility condition is satisfied, in which:
A(z)·B(z)−C(z)

is divisible by a target polynomial Z(z) that depends on the circuit only.

Note that the polynomials are hidden using elliptic curve points. The proof consists of the points A(τ)·G, B(τ)·G, C(τ)·G that are used in a bilinear pairing e(▪, ▪) to ensure QAP divisibility, such that:

$$e ( A ( τ ) \cdot G , B ( τ ) \cdot G ) = e ( C ( τ ) \cdot G , G ) e ( H ( τ ) \cdot G , Z ( τ ) \cdot G ) ,$$

where knowledge of the polynomial H(τ) must be proven. If the above equality holds true, then the verifier knows that the prover has knowledge of a valid assignment. The verification protocol also checks that:
the prover has used the proving keys pk to calculate A(τ)·G, B(τ) G, C(τ)·G,
the prover has used the same valid assignment in each of A(τ)·G, B(τ)·G, C(τ)·G, and
the prover has declared the correct public input x.

The third verification phase returns an accept or reject decision depending on whether the proof is found to be valid or invalid, respectively. Note that no matter the size of the function, the proof that is used in the four verification calculations is always fixed at eight elliptic curve points. This satisfies the succinctness property of the zkSNARK.

Anyone with knowledge of this proof and the corresponding circuit can verify the calculation, making it a non-interactive proof. The verifier does not learn any information about the secret, and it is computationally infeasible for a proof to succeed without being correctly calculated i.e., it is computationally infeasible for a prover to calculate a proof that is accepted aside from acting honestly. The verification key will ensure the verifier that the pre-defined statement (meaning the circuit) is indeed being validated without the verifier directly using the circuit.

Whilst Groth16-like constructions of zkSNARKs are referred to above, embodiments are not limited to this type of ZKP. In particular, the ZKP may be a multi-party computation (MPC) based zkSNARK (e.g., zkBOO), a STARK, or Bulletproofs etc.

### Key Derivation Protocol

One example key derivation protocol is the BIP32 specification which describes a method to derive multiple private/public keypairs from a single binary seed. The method generates a Hierarchical Deterministic (HD) wallet of keys that form a tree-like data structure.

A first extended key (master key) is created by putting a seed through a HMAC-SHA512 hash function. In particular, the mater key of a HD wallet is generated by the following steps:
1. Generate a random seed byte sequence S ∈_{R} [symbol] ₙ where n is the order of an elliptic curve group.
2. Calculate I=HMAC512(Key,Data) where Key=“Bitcoin seed” and Data=S. HMAC512(Key,S) is defined to be:

$$HMAC 512 ( Key , S ) = SHA 512 ( ( Key ⊕ opad ) ‖ SHA 512 ( ( Key ⊕ ipad ) ‖ S ) )$$

where opad is a 128-byte outer padding of repeating bytes valued at 0x5c, ipad is a 128-byte inner padding of repeating bytes valued at 0x36 and ⊕ denotes the bitwise exclusive (XOR) operation.
3. Split I is two 32-byte sequences labelled I_{L} and I_{R} for the left and right 32-bytes, respectively.
4. Define m=parse₂₅₆(I_{L}) where the function parse₂₅₆ translates I_{L} into a 256-bit number with the most significant byte first. This is the master private key m.
5. Define cₘ=I_{R} as the master chain code.

The extended private master key is defined to be (m, cₘ). The private master key should necessarily be kept secret. It is used to derive child keys which may be used as desired.

All extended keys can derive child extended keys. An extended key is private key or public key than can be used to derive new keys in a HD wallet. An extended private key is a private key coupled with a chain code. A corresponding extended public key can be created by taking the private key and calculating its corresponding public key and coupling that with the same chain code.

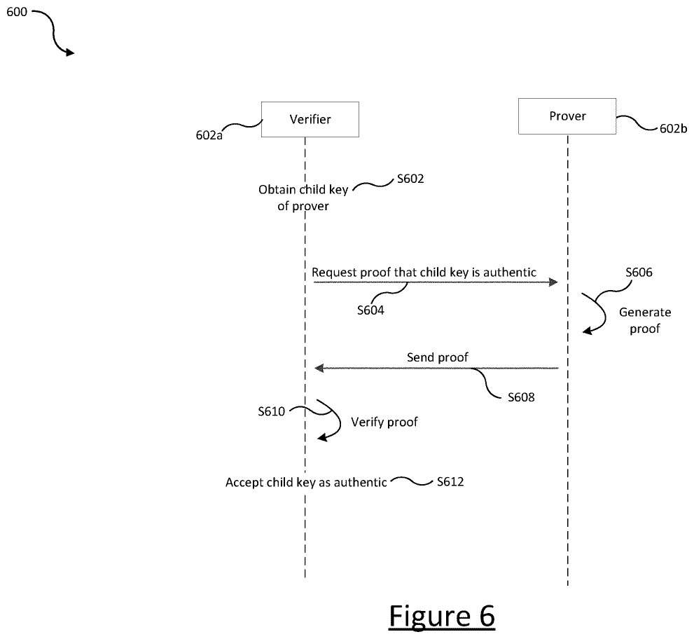

In one example, a parent private key can be used to derive a child private key, this is illustrated in FIG. 5.

The function (skᵢ, cᵢ)←CKDₚᵣᵢᵥ((Skₚₐᵣ, cₚₐᵣ), i) derives an extended child private key (skᵢ, cᵢ) from an extended parent private key (skₚₐᵣ, cₚₐᵣ) and index i in the following way:
1. The index i encodes whether the child key is to be hardened or unhardened:
   a) If 0 i≤2³¹, the child key is unhardened. Calculate:

$$I = HMAC 512 ( Key = {c}_{par} , Data = {ser}_{P} ( {sk}_{par} \cdot G ) ‖ {ser}_{32} ( i ) )$$

where the function serₚ(skₚₐᵣ·G) serialises the elliptic curve coordinate (x, y)=skₚₐᵣ·G as a 33-byte sequence using the SEC1 compressed form: (0x02 or 0x03)∥ser₂₅₆(x) where the first byte depends on the parity of the y coordinate. The function ser₃₂(i) serialises the 32-bit integer i as a 4-byte sequence with the most significant byte first.
   b) If 2³¹<i<2³², the child key is hardened. Calculate:

$$I = HMAC 512 ( Key = {c}_{par} , Data = 0 \times 00 ‖ {ser}_{256} ( {sk}_{par} ) ‖ {ser}_{32} ( i ) )$$

where the function ser₂₅₆(skₚₐᵣ) serialises the integer skₚₐᵣ as a 32-byte sequence (33-bytes long with the 0x00 pads).
2. Split I into two 32-byte sequences labelled I_{L} and I_{R} for the left and right 32-bytes, respectively.
3. The child private key is skᵢ=skₚₐᵣ+parse₂₅₆(I_{L}) mod n. That is, the child private key is generated using the parent private key and a first portion (I_{L}) of a hash function output that is generated when the parent private key is supplied as an input into the HMAC-SHA512 hash function.

4. Define cᵢ=I_{R} as the child chain code.

This method can be used to derive up to 2³² child keys from a single parent. Additionally, each child can be taken to be a parent key in the method above to derive grandchild keys and so on. There is no limit to the depth of generations of child keys (aside from recoverability considerations).

In a similar manner, a parent public key can be used to derive a child public key, this is illustrated in FIG. 5. In this example, the child public key is generated using the parent public key and the first portion (I_{L}) of a hash function output that is generated when the parent public key is supplied as an input into the HMAC-SHA512 hash function.

As shown in FIG. 5, the child chain code I_{R}, which corresponds to the remaining portion of the hash function output that is generated when the parent private/public key is supplied as an input into the HMAC-SHA512 hash function, is then used as a parent chain code input into the HMAC-SHA512 hash function when the child public/private key “becomes a parent” and is used to derive a child key.

Given the information necessary to derive one unhardened child key from a parent, it is possible (for a sender) to derive other child keys on behalf of the wallet owner (the receiver), which minimises the rounds of communication required between both parties. However, this type of configuration exposes HD wallet (including BIP32) servers to privilege escalation attacks.

Namely, given an extended parent public key (pkₚₐᵣ, cₚₐᵣ) and any unhardened child private key skᵢ, an attacker can obtain the parent secret key skₚₐᵣ by computing skₚₐᵣ=skᵢ-I_{L}. An attacker could then derive all the child keys of a given depth and key derivation path up to (and including) a hardened parent key.

The derivation path in HD wallets is defined as an n-tuple of n key indexes separated by ‘/’. The BIP32 default wallet layout adopts a 3-tier hierarchy following the master key m and is defined by the derivation path:
m/account′/change/address_index

In this wallet configuration, child keys at the first depth of the hierarchical data structure (account′) are hardened. If an attacker gains knowledge of the unhardened child private key (change or address_index levels), they would then be able to compromise the entire account by accessing the funds of all the child keys using the above privilege escalation attack.

### Proof Generation and Verification

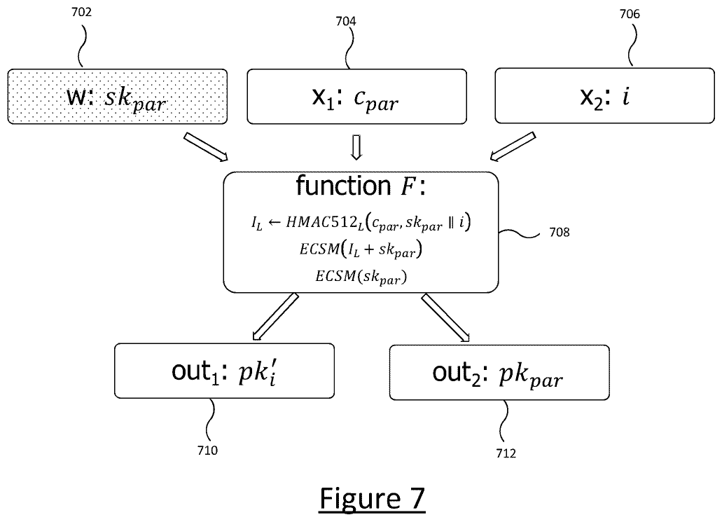

FIG. 6 illustrates the steps performed by a verifier computer equipment 602a (a computing device) and a prover computer equipment 602b (a computing device) in a process 600 for verifying the authenticity of a child public key.

At step S602, the verifier computer equipment 602a associated with a verifier obtains a child public key associated with an entity. It will be appreciated that the verifier computer equipment 602a may obtain the child public key in a number of different ways. In one example, the verifier computer equipment 602a may obtain the child public key by requesting, and subsequently receiving, the child public key from the prover computer equipment 602b.

At step S604, the verifier computer equipment 602a transmits a message to the prover computer equipment 602b requesting proof that the child public key is authentic. That is, the verifier computer equipment 602a requests proof that a key derivation protocol has been used to derive the child public key from a parent key.

At step S606, in response to receiving the message, the prover computer equipment 602b generates a ZKP for use in proving that the child public key is authentic and at step S608 transmits the proof to the verifier computer equipment 602a. The prover computer equipment 602b may be associated with the entity who is associated with the child public key (i.e. the child public key may be associated with the prover). However this is not essential and the prover computer equipment 602b need not be associated with the entity that is associated with the child public key.

At step S610, the verifier computer equipment 602a is used to verify the proof, and by successfully verifying the proof, the verifier can be sure that a key derivation protocol has been used to derive the child public key from a parent key, and thus at step S612 the verifier accepts the child public key as authentic.

The process 600 is described in further detail below in the context of a verifier sending a payment to a prover and the proof proving that a payment address derived from the child public key is authentic. As will be described later, embodiments of the present invention are not limited to this payment context.

### Hardened Child Key Derivation Proof

Given an extended parent public key (pkₚₐᵣ, Cₚₐᵣ), one can prove that an unhardened child public key pkᵢ has been derived correctly with respect to a BIP32 derivation path using the formula:

$${pk}_{i} = {pk}_{par} + HMAC {512}_{L} ( {c}_{par} , {pk}_{par} ‖ i ) \cdot G$$

where the elliptic curve operators + and · denote point addition and scalar point multiplication, respectively and HMAC512_{L} is the left 32-bytes of the output of the HMAC function (I_{L}). Ignoring privacy concerns, it is safe for a third party to have knowledge of an extended parent public key. This knowledge is useful for the case that multiple transactions are being sent to the owner of the public key, since a sender can derive payment addresses on behalf of the receiver using the child key derivation (CKD) formula above. This reduces the rounds of communication required between both parties.

In contrast, a hardened child public key pkᵢ′0 cannot be derived from an extended parent public key due to there being a secret input to the HMAC function:

$${pk}_{i}^{′} = {pk}_{par} + HMAC {512}_{L} ( {c}_{par} , {sk}_{par} ‖ i ) \cdot G$$

The key derivation formula here shows that a verifier would need to know the parent private key skₚₐᵣ, which is necessarily a secret.

We describe herein a method for proving the derivation of a hardened child key using a ZKP. This would allow a third party to verify the correctness of the CKD computation without knowledge of the parent private key i.e., to prove that a hardened child public key is derived from a given parent public key.

In this embodiment, the parent key is a private parent key and the child public key is a hardened child public key.

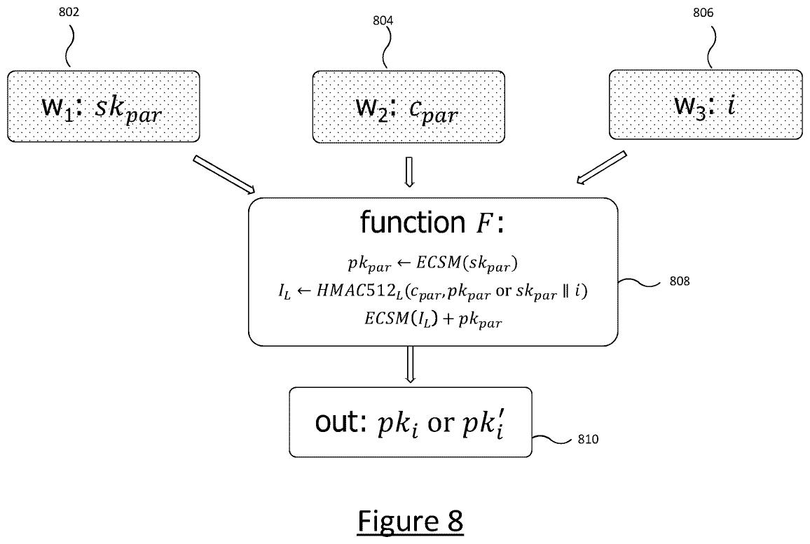

A circuit, C, that is illustrated in FIG. 7 represents the BIP32 CKD function for hardened child public keys pk′ᵢ and for which knowledge of the function's inputs given one or more known outputs will be proved. FIG. 7 is used to show which inputs/outputs are public/secret in the proof generation/verification process.

The circuit, C, is based on the following assumptions:
The extended public parent key (pkₚₐᵣ, cₚₐᵣ) is known. The parent public key may be unhardened or hardened

$$( {pk}_{par}^{′} ) ;$$

the notation pkₚₐᵣ is used here for simplicity.
The BIP32 CKD method is known such that (pkᵢ, cᵢ)←CKD_{pub}((pkₚₐᵣ, cₚₐᵣ), i)) is the i^{th} unhardened child key and

$$( {pk}_{i}^{′} , {c}_{i} ) ← {CKD}_{pub} ( ( {sk}_{par} , {c}_{par} ) , i ) )$$

is the i^{th} hardened child key.
The elliptic curve generator point G is hardcoded for both prover and verifier, and therefore can be omitted from the inputs.

The inputs to the circuit are:
Secret input is \vec{w}
   Parent private key skₚₐᵣ 702
Public input \vec{x}
   Parent chain code cₚₐᵣ 704
   Key index i 706

and the outputs are the child public key pkᵢ 710 and the parent public key pkₚₐᵣ 712.

The prover computer equipment 602b executes the circuit, C, to output a valid assignment. That is, the prover computer equipment 602b supplies the inputs referred above to the circuit, C, to generate the outputs referred to above.

A valid assignment (X, W) to the circuit comprises 3 inputs(skₚₐᵣ,Cₚₐᵣ,i), 2 outputs

$$( {pk}_{par} , {pk}_{i}^{′} ) ,$$

and auxiliary variables which include

$$( {sk}_{par} ‖ i , {I}_{L} , {sk}_{i}^{′} ) .$$

FIG. 7 illustrates whether the inputs are public or secret (denoted by a shaded box), and the computation occurring within the function F 708 that produces the specified outputs. The auxiliary variables generated during execution of the function F 708 are not explicitly shown in FIG. 7.

At a high-level, the computational steps in the circuit for this valid assignment are as follows:
Step 1. Set secret (in₁) and public (in₂, in₃) inputs:
   in₁=skₚₐᵣ, in₂=Cₚₐᵣ, in₃=i
Step 2. Execute function F 708 using given inputs:
   i. Compute CKDₚᵣᵢᵥ((in₁, in₂), in₃):
      a. Compute aux₁=(in₁∥in₃)
      b. Compute aux₂=HMAC512_{L}(in₂, aux₁)
      c. Compute aux₃=in₁+aux₂
   ii. Compute ECSM(▪):
      a. Set operand (▪) as skₚₐᵣ←out,
      b. Set operand (▪) as aux₃←out₂
Step 3. Publish outputs of function F such that out₂←CKD_{Pub}((out₁, in₂), in₃):

$${out}_{1} = {pk}_{par} , {out}_{2} = {pk}_{i}^{′} .$$

If an extended child public key is desired in the output, the chain code cᵢ can be computed by replicating Step 2ib of the circuit for the rightmost output I_{R} of the HMAC function.

Consider a scenario whereby Alice 103a (verifier) wishes to purchase a product of high value from a certified merchant Bob 103b (prover) who has a certificate linking his parent public key to his identity. In this scenario the verifier computer equipment 602a corresponds to Alice's computer equipment 102a, and the prover computer equipment 602b corresponds to Bob's computer equipment 102b.

Alice 103a cannot generate a child key and resultant payment address on behalf of Bob 103b since Bob 103b only accepts payments to hardened public keys.

Alice 103a obtains a payment address from Bob (either directly from the prover computer equipment 602b, from Bob's wallet server, or by some other means) that is derived from an uncertified hardened child public key pk

$${pk}_{i}^{′} .$$

A wallet server may correspond to one of the blockchain nodes 104 referred to above or a server coupled to one of the blockchain nodes 104. A wallet server derives and stores all the keys in a user's wallet, which are then used to derive payment addresses. It will be appreciated that such keys may be derived one at a time or be intermittently derived a few at a time.

At step S602 Alice 103a also obtains the hardened child public key pkᵢ (either directly from the prover computer equipment 602b, from Bob's wallet server, or by some other means). At step S604, Alice 103a requests proof that this hardened child public key is authentic before finalising their payment transaction.

At step S606, the prover computer equipment 602b generates a proof based on a valid assignment to the public circuit representing the hardened CKD function.

To generate the proof at step S606, the prover computer equipment 602b supplies the input ‘ [symbol] ’ into a proof generation process which in this example embodiment includes the public inputs to the function F 708 (the parent chain code cₚₐᵣ 704, and the key index i 706) and the public outputs from the function F 708 (the hardened child public key

$${pk}_{i}^{′}$$

710 and the parent public key pkₚₐᵣ 712).

To generate the proof at step S606, the prover computer equipment 602b additionally supplies the input ‘W’ into the proof generation process which includes all secret parameters in the valid assignment e.g., secret inputs to the function F 708 (the parent private key skₚₐᵣ 702) and any secret auxiliary variables.

The prover computer equipment 602b additionally supplies the proving key pk_{F}, as an input into the proof generation process.

The proof generation process implemented by the prover computer equipment 602b uses the inputs ‘ [symbol] ’, ‘W’ and the proving key pk_{F}, to generate a proof π. Bob's proof shows that the hardened public key that Alice 103a obtained from Bob is indeed the child of his certified parent key.

In this example, the ZKP is constructed as follows:
Given

$${pk}_{i}^{′} ,$$

provide a zkSNARK proof π of a witness w for

$$\{ s {k}_{par} , {c}_{par} , i , {pk}_{i}^{′} : ∃ w s . t .$$

$${pk}_{p a r} = w \cdot G ,$$

$${pk}_{i}^{′} = {pk}_{p a r} + HMAC 51 {2}_{L} ( {c}_{p a r} , w \vert \vert i ) \cdot G \}$$

In order to verify the proof, the verifier computer equipment 602a supplies the proof and the input ‘ [symbol] ’ into a proof verification process which in this example embodiment includes the public inputs to the function F 708 (the parent chain code cₚₐᵣ 704, and the Key index i 706) and the public outputs from the function F 708 (the hardened child public key

$${pk}_{i}^{′}$$

710 and the parent public key pkₚₐᵣ 712).

The verifier computer equipment 602a additionally supplies the verification key Vk_{F}, as an input into the proof verification process.

The proof verification process implemented by the verifier computer equipment 602a uses the proof, input ‘ [symbol] ’, the verification key vk_{F} to verify the proof π. The proof verification process outputs an accept or reject decision depending on whether the proof is found to be valid or invalid. By verifying Bob's proof at step S610, Alice 103a can be sure that the hardened child public key pk′ᵢ has been derived correctly using the BIP32 derivation method from the parent private key skₚₐᵣ. This assures Alice 103a that the payment address they have for Bob is indeed the correct one.

The verifier (Alice 103a) has prior knowledge of a copy of the parent public key pkₚₐᵣ (which is part of input ‘ [symbol] ’). In some embodiments, the verifier computer equipment 602a may receive from the prover computer equipment 602b, a parent public key used by the prover computer equipment 602b to generate the proof, and in addition to the proof verification, determining the authenticity of the child public key may be further based on if the parent public key pkₚₐᵣ used by the prover computer equipment 602b to generate the proof matches the copy of the parent public key that the verifier has prior knowledge of. That is, if the parent public key pkₚₐᵣ used by the prover computer equipment 602b to generate the proof matches the copy of the parent public key, this confirms to Alice 103a that the identity of the prover (Bob 103b) is what is expected and the child public key is determined to be authentic.

This embodiment has been described above with reference to the input ‘ [symbol] ’ used in the proof generation and proof verification processes comprising some public inputs ‘x’ (e.g. the parent chain code cₚₐᵣ 704, and the key index i 706). It will be appreciated that one or both of the parent chain code cₚₐᵣ 704, and the key index i 706 may be a secret input ‘w’ that is part of the input ‘W’ used in the proof generation process. Each of the parent chain code cₚₐᵣ 704 and the key index i 706 can either be secret or public.

### Hardened or Unhardened Child Key Derivation Proof

Knowledge of different extended keys, whether hardened or unhardened, may lead to the following three scenarios:
1. Knowledge of an extended public parent key: The attacker gains knowledge of the parent public key and parent chain code and is able to derive all unhardened child public keys.
2. Knowledge of an extended public parent key and unhardened child private key: The attacker can perform a privilege escalation attack.
3. Knowledge of multiple extended public child keys: The attacker has knowledge of the 4-byte parent fingerprint included in the extended serialisation format and can identify relationships between sibling keys.

In all three scenarios, the public nature of the blockchain means that an attacker may be able to track patterns of spending. In addition to privacy issues, in scenario 2, the attacker can steal the funds associated with a compromised account.

We describe herein a method that hides the receiver's extended parent public key where a ZKP is constructed to prove the correct derivation of either unhardened or hardened child public keys. The solution described herein secures HD wallets against privilege escalation attacks and preserves the privacy of the receiver by hiding the extended parent public key.

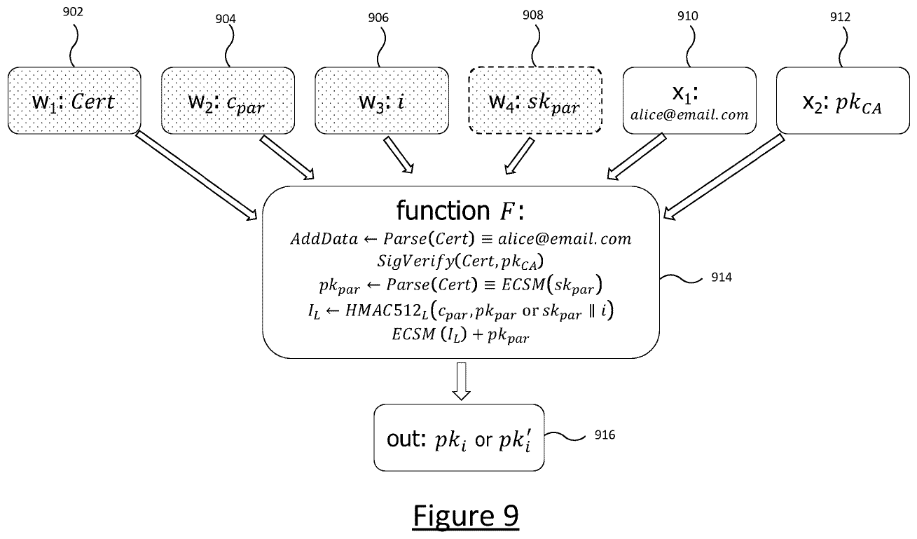

A circuit, C, that is illustrated in FIG. 8 represents the BIP32 CKD function for either hardened child public keys pk′ᵢ or unhardened child public keys pkᵢ and for which knowledge of the function's inputs given one or more known outputs will be proved.

FIG. 8 is used to show which inputs/outputs are public/secret in the proof generation/verification process.

The circuit, C, is based on the following assumptions:
The extended public parent key (pkₚₐᵣ, cₚₐᵣ) is not known.
The BIP32 CKD method is known such that (pkᵢ, cᵢ)←CKD_{pub}((pkₚₐᵣ, Cₚₐᵣ), i)) is the i^{th} unhardened child key or

$$( {pk}_{i}^{′} , {c}_{i} ) ← {CKD}_{p u b} ( ( s {k}_{p a r} , {c}_{p a r} ) , i ) )$$

The elliptic curve generator point G is hardcoded for both prover and verifier.

The inputs to the circuit are:
Secret input is
   Private parent key skₚₐᵣ 802
   Chain code corresponding to the parent key cₚₐᵣ 804
   Key index i 806

and the output is:
Unhardened, pkᵢ or hardened,

$${pk}_{i}^{′}$$

child public key 810.

The parent public key may be unhardened or hardened

$$( {pk}_{par}^{′} ) ;$$

the notation pkₚₐᵣ is used here for simplicity.

The circuit can take either public or private parent keys as inputs to derive unhardened or hardened child keys in the outputs, respectively. To accommodate for both types of outputs, the private key skₚₐᵣ can be set as an input and the corresponding public key can be derived within the circuit as demonstrated by the first line of the function F 808 in the schematic of FIG. 8.

Whilst FIG. 8 illustrates the private key skₚₐᵣ being set as an input, the public parent key pkₚₐᵣ can instead be set as an input, although this limits the output to unhardened child keys only.

The prover computer equipment 602b executes the circuit, C, to output a valid assignment. That is, the prover computer equipment 602b supplies the inputs referred above to the circuit, C, to generate the outputs referred to above.

A valid assignment ( [symbol] ,W) to the circuit comprises 3 inputs (skₚₐᵣ, Cₚₐᵣ,i), 1 output (out), and auxiliary variables which include

$${pk}_{par} , \vert \vert i , {I}_{L} , ( {I}_{L} \cdot G ) , where = {sk}_{p a r}$$

$$for out ≡ {pk}_{i}^{′} or = {pk}_{par} for out ≡ {pk}_{i} .$$

FIG. 8 illustrates whether the inputs are public or secret (denoted by a shaded box), and the computation occurring within the function F 808 that produces the specified outputs. The auxiliary variables generated during execution of the function F 808 are not explicitly shown in FIG. 8.

At a high-level, the computational steps in the circuit for this valid assignment are as follows:
Step 1. Set all secret inputs (in₁, in₂, in₃):
   in₁=skₚₐᵣ, in₂=Cₚₐᵣ, in₃=i.
Step 2. Execute function F 808 using given inputs:
   i. Compute aux₁=ECSM(in₁)
   ii. If 0≤in₃<2³¹:
      a. Compute aux₂=(aux₁∥in₃)
   Elseif 2³¹<in₃<2³²:
      b. Compute aux₂=(in₁∥in₃)
   Else:
      c. Fail.
   iii. Compute aux₃=HMAC512_{L}(in₂, aux₂)
   iv. Compute aux₄=ECSM(aux₃)
   v. Compute out=aux₁+aux₄:
      If in₃<2³¹:
         a. out ≡pkᵢ
      Else:
         b.

$$out ≡ {pk}_{i}^{′}$$

Step 3. Publish output of the function F such that out=CKD((in₁, in₂), in₃):

$$out ≡ {pk}_{i} or {pk}_{i}^{′}$$

If an extended child public key is desired in the output (output includes chain code cᵢ), the chain code cᵢ can be computed by replicating step 2iii for the rightmost output I_{R} of the HMAC function.

For a given extended parent key, it is possible to set both the key (public or private) and chain code as secret inputs to demonstrate that it is possible to prove the derivation of a child key without any knowledge of the inputs. A third-party requesting proof that a child public key has been derived correctly can therefore verify such a proof without explicit knowledge of the inputs to the circuit. This is because the verification key vk_{F} used in the zkSNARK protocol is linked to the circuit. Knowledge of the circuit (by being in possession of the verification key vk_{F}) is therefore sufficient for the verifier to accept or reject the output of the circuit. Moreover, setting all inputs to the circuit as secret ensures that no information can be leaked about the owner's identity and/or their transaction history.

If a public input is desired, it is possible to set only part of the extended parent key as a secret input; but the full extended parent key is not known. That is, if the public parent key pkₚₐᵣ is set as an input, the chain code 804 corresponding to the parent key cₚₐᵣ is set as a secret input. If the private parent key skₚₐᵣ is set as an input, the chain code 804 corresponding to the parent key cₚₐᵣ can be set as a public or secret input. The key index 806 can either be secret or public.

Consider a scenario whereby a user Alice 103a wishes to send a payment to another user, Bob 103b. In this scenario the verifier computer equipment 602a corresponds to Alice's computer equipment 102a.

Alice 103a has an uncertified public key pk′ᵢ for Bob 103b and is unsure whether the resultant payment address is authentic. This is obtained at step S602 (either directly from the prover computer equipment 602b, from Bob's wallet server, or by some other means).

At step S604, Alice 103a requests proof that this public key is authentic before finalising their payment transaction. Here the prover computer equipment 602b may correspond to the computer equipment 102b associated with Bob 103b or a wallet server associated with Bob's BIP32 wallet provider. We refer below to an example whereby the prover computer equipment 602b corresponds to a wallet server associated with Bob's BIP32 wallet provider.

At step S606, the prover computer equipment 602b generates a proof based on a valid assignment to the public circuit representing the CKD function.

To generate the proof at step S606, the prover computer equipment 602b supplies the input ‘ [symbol] ’ into a proof generation process which in the example shown in FIG. 8 includes no public inputs to the function F 808 and the public output 810 from the function F which is the hardened child public key pk′ᵢ in this example.

To generate the proof at step S606, the prover computer equipment 602b additionally supplies the input ‘W’ into the proof generation process which includes all secret parameters in the valid assignment e.g., secret inputs to the function F 808 (the parent private key skₚₐᵣ 802, the parent chain code cₚₐᵣ 804, and the key index i 806) and any secret auxiliary variables.

The prover computer equipment 602b additionally supplies the proving key pk_{F}, as an input into the proof generation process.

The proof generation process implemented by the prover computer equipment 602b uses the inputs ‘ [symbol] ’, ‘W’ and the proving key pk_{F} to generate a proof π. Bob's proof shows that the hardened child public key pk′ᵢ that Alice 103a obtained from Bob is indeed the child of his certified parent key.

In order to verify the proof, the verifier computer equipment 602a supplies the proof and the input ‘ [symbol] ’ into a proof verification process which in the example illustrated in FIG. 8 includes no public inputs to the function F 808 and the public output from the function F 808 (the hardened child public key pk′ᵢ 810).

The verifier computer equipment 602a additionally supplies the verification key Vk_{F}, as an input into the proof verification process. By verifying Bob's proof at step S610, Alice 103a can be sure that the hardened child public key pk′ᵢ has been derived correctly using the BIP32 derivation method from the parent private key skₚₐᵣ. This assures Alice 103a that the payment address they have for Bob is indeed the correct one.

In another example, the prover computer equipment 602b generates a proof using a valid assignment constructed from Bob's extended parent public key (pkₚₐᵣ, cₚₐᵣ) to prove that the unhardened public key pkᵢ was correctly derived from the wallet's CKD function. Here, the proof is limited to that derived using the parent public key as an input i.e., the output here is an unhardened child public key pkᵢ.

By verifying the wallet provider's proof π, Alice is satisfied that the payment address derived from the unhardened child public key pkᵢ is correct.

The ZKP is constructed as follows:
Given pkᵢ, provide a zkSNARK proof π of a witness w for

$$\{ {pk}_{par} , {c}_{par} , i , {pk}_{i} : ∃ w = ( {w}_{1} , {w}_{2} , {w}_{3} ) s . t .$$

$${pk}_{i} = {w}_{1} + HMA C {512}_{L} ( {w}_{2} , {w}_{1} \vert \vert {w}_{3} ) \cdot G \}$$

Whilst this embodiment has been described above with reference to the input ‘W’ used in the proof generation process comprising the parent chain code cₚₐᵣ 804, and the key index i 806, this is merely an example, and one or both of the parent chain code cₚₐᵣ 804 and the key index i 806 may be a public input ‘x’ that is part of the input ‘ [symbol] ’ used in the proof generation and proof verification processes. Each of the parent chain code Cₚₐᵣ 804 and the key index i 806 can either be secret or public.

### Identity Linked Child Key Derivation Proof

In traditional Public Key Infrastructure (PKI), a Certificate Authority (CA) issues digital certificates that certify ownership of private-public keypairs. The owner of a keypair creates a certificate request to have their public key certified by a CA and signs the request using their corresponding private key to prove ownership of the keypair. The CA typically verifies identity-related information before signing and issuing digital certificates.

The CA is a trusted authority, and their digital signature ensures the authenticity and integrity of a certificate. The following algorithms summarise the creation and verification of a digital signature, for which the inputs and outputs are listed in Table 2 below:
I. Signing—A signer uses their private key sk in a digital signature algorithm to sign a message m. The signature Sig(m), the message m and the signer's public key pk is then sent to the verifier.
II. Verifying—The verifier uses the signer's public key pk and the same digital signature algorithm to verify the signature Sig(m) and validate the authenticity of the message m.

TABLE 2

| Algorithm | Inputs | Outputs |
|---|---|---|
| Signing | Message m, Private key sk | Digital signature |
| | | Sigₛₖ(m) |
| Verifying | Message m, Public key pk, Digital | Decision bit 1 or 0 |
| | signature Sig(m) | |

The certificate issued by the CA contains both the signature on the message Sig(m) and the message m, and is written as:

$$Cert = ( {Sig}_{{sk}_{C A}} ( m ) , m ) ,$$

where the message m=(MetaData, PubKey,AddData) is the data structure to be signed with the CA's private key sk_{CA} using the appropriate digital signature algorithm for the CA's keypair (e.g., ECDSA for elliptic curve keypairs).

The certificate can be validated by verifying the CA's signature on its contents (the message m) and is denoted as

$$SigVerify ( Cert , p {k}_{C A} ) ,$$

where the signature in Cert is verified with the CA's public key pk_{CA} using the same signature algorithm as the signing phase. Verifying the CA's signature ensures the authenticity of the certificate since the trusted CA uses its keypair (pk_{CA}, sk_{CA}) to certify the data. The integrity of the message is provided by the digital signature algorithm, which typically hashes the message instead of signing the raw data so that any change in the message after it has been signed invalidates the signature on account of the deterministic property of hash functions.

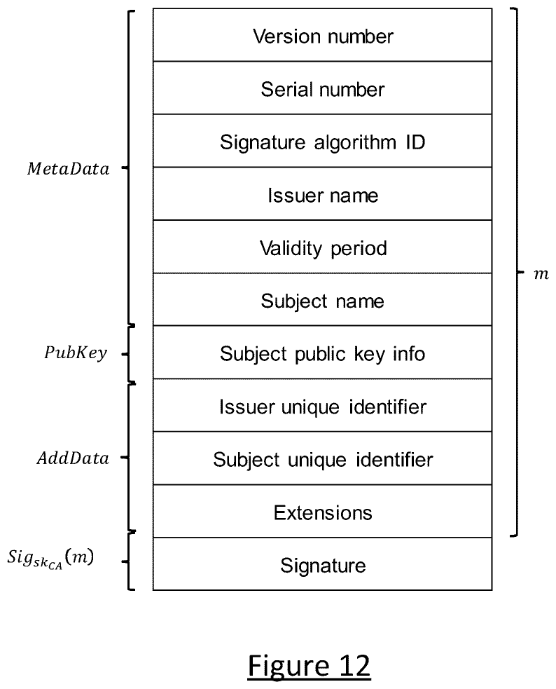

The certificate issued by the CA may be based on the widely accepted international X.509 PKI standard (as illustrated in FIG. 12) which has the following fields:
MetaData includes a digital certificate version number (version 3, at the time of writing), the unique ID assigned to the certificate, the public key algorithm the CA uses for its signatures, a name to uniquely identify the issuing CA, the expiration date after which the certificate is not trusted and a name to uniquely identify the receiver of the certificate.
PubKey is the receiver's public key and public key algorithm.
AddData denotes additional information that the CA and/or receiver wants signed e.g., contact details, social security number. Note that these entries are optional, although the ‘Extensions’ field normally specifies the type of digital certificate.
m=(MetaData, PubKey, AddData) is the message to be signed.
Sigₛₖ_{_{CA}}(m) is the CA's signature.

It will be appreciated that embodiments described herein are not limited to any particular certificate standard.

There are many benefits to a user linking their identity to their public key. One simple example is improved user experience; it is far simpler to share human-readable contact or identity-based information than it is to share a long string of hexadecimal digits that constitutes a public key. Identity-based information is comparatively more memorable, which makes transactions between users more accessible.

An important benefit is the growing need for anti-money laundering measures to be in place, especially for users transacting pseudonymously over public blockchains. For example, a user can have their digital identity verified by a certifying authority (CA).

Transactions signed by a certified private key can be audited and thus provides assurance to a party accepting digital payments.

The certification of a public key can be extended to certifying an entire wallet of keys when a HD wallet such as BIP32 is used. A user can simply certify a master or account key so that all its child keys are provably linked to a verified identity.

We describe herein a method for proving that a child key is derived from a certified parent public key, where the parent key is hidden to preserve privacy. We first describe the setup phase in which a prover (Alice) has their identity verified by a CA. A ZKP is subsequently generated when a verifier (Bob) uses the prover's identity information to request a child public key from their wallet server.

The following describes the certification of the prover's (Alice's) parent public key pkₚₐᵣ:
1. Alice submits a certificate request to an issuing CA.
2. Alice receives a signed digital certificate of the form:

$$Cert = ( {Sig}_{{sk}_{C A}} ( m ) , m )$$

where m=(MetaData,PubKey,AddData) is the identity-related message to be signed that includes Alice's public key pkₚₐᵣ in PubKey and a unique identifier of Alice (e.g. her email address alice@email. com) in AddData, and sk_{CA} is the CA's private key that is used to generate the signature Sigₛₖ_{_{CA}}(m) on the message.
3. Alice validates her certificate by verifying the CA's signature using the public key pk_{CA} as:

$$SigVerify ( Cert , p {k}_{C A} ) .$$

4. Alice submits Cert to her wallet server.

Next, we describe how a ZKP can be generated from the identity-linked parent key pkₚₐᵣ using the contents of the certificate Cert.

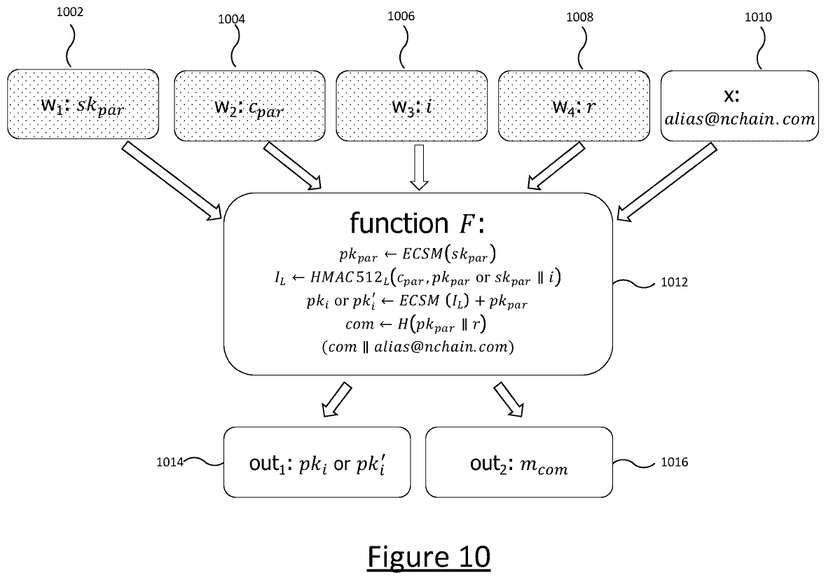

A circuit, C, that is illustrated in FIG. 9 represents the BIP32 CKD function for either hardened child public keys pk′ᵢ or unhardened child public keys pkᵢ and for which knowledge of the function's inputs given one or more known outputs will be proved. FIG. 9 is used to show which inputs/outputs are public/secret in the proof generation/verification process.

The circuit, C, is based on the following assumptions:
The extended public parent key (pkₚₐᵣ, cₚₐᵣ) is not known.
The receiver's identity information in AddData is known.
The BIP32 CKD method is known such that (pkᵢ, cᵢ)←CKD_{pub}((pkₚₐᵣ, Cₚₐᵣ), i)) is the i^{th} unhardened child key and

$$( {pk}_{i}^{′} , {c}_{i} ) ← {CKD}_{p u b} ( ( s {k}_{p a r} , {c}_{p a r} ) , i ) )$$

The elliptic curve generator point G is hardcoded for both prover and verifier.

The inputs to the circuit are:
Secret input is \vec{w}
   Receiver's signed digital certificate Cert (contains the certified public parent key pkₚₐᵣ) 902
   Chain code corresponding to parent key cₚₐᵣ 904
   Index i 906
   (Optional) Private parent key skₚₐᵣ 908 if hardened key in output
Public input x
   prover's email address alice@email.com 910 (or any other unique identifier of the prover)
   Issuing CA's public key pk_{CA} 912

and the outputs are:
Unhardened, pkᵢ or hardened,

$${pk}_{i}^{′}$$

child public key 916.

The parent public key may be unhardened or hardened

$$( {pk}_{par}^{′} ) ;$$

the notation Pkₚₐᵣ is used here for simplicity.

The prover computer equipment 602b executes the circuit, C, to output a valid assignment. That is, the prover computer equipment 602b supplies the inputs referred above to the circuit, C, to generate the outputs referred to above.

A valid assignment ( [symbol] ,W) to the circuit comprises 6 inputs (Cert, cₚₐᵣ, i, skₚₐᵣ, Cₚₐᵣ, alice@email. com, pk_{CA}), 1 output (out), and auxiliary variables which include AddData, pkₚₐᵣ, (skₚₐᵣ·G), ▪∥i, I_{L}, (I_{L}·G), where

$$■ = {sk}_{par} for out ≡ {pk}_{i}^{′} or ■ = {pk}_{par} for out ≡ {pk}_{i} .$$

At a high-level, the computational steps in the circuit for this valid assignment are as follows:
Step 1. Set secret (in₁, in₂, in₃, in₄) and public (in₅, in₆) inputs as:

$${in}_{1} = Cert , {in}_{2} = {c}_{par} , {in}_{3} = i , {in}_{4} = {sk}_{par} ,$$

$${in}_{5} = alice @ email . com , {in}_{6} = {pk}_{CA} .$$

Step 2. Execute function F 914 using given inputs:
   i. Compute aux₁←Parse(in₁) for AddData:
      If aux₁in₅:
         a. Compute SigVerify(in₁, in₆)
      Else:
         b. Fail.
   ii. Compute aux₂←Parse(in₁) for PubKey:
   If 2³¹≤in₃<2³²:
      a. Compute aux₃=ECSM(in₄)
      If aux₃-aux₂:
         A. Continue to Step 2iii.
      Else:
         B. Fail.
   Else:
      b. aux₃=null string.
   iii. If 0≤G in₃<2³¹:
      a. Compute aux₄=(aux₂∥in₃)
   Elseif 2³¹≤in₃<2³²:
      b. Compute aux₄=(in₄∥in₃)
   Else:
      c. Fail.
   iv. Compute aux₅=HMAC512_{L}(in₂, aux₄)
   v. Compute aux₆=ECSM(aux₅)
   vi. Compute out=aux₂+aux₆:
   If in₃<2³¹:
      a. out -pkᵢ
   Else:
      b.

$$out ≡ {pk}_{i}^{′}$$

Step 3. Publish output of function F:

$$out = {pk}_{i} or {pk}_{i}^{′} .$$

If an extended child public key is desired in the output (output includes chain code cᵢ), the chain code cᵢ can be computed by replicating step 2iv for the rightmost output I_{R} of the HMAC function.

When the circuit outputs unhardened child keys only, the fourth input (skₚₐᵣ 908) is not necessary.

The circuit, C, first checks that the prover's publicly known identity data i.e., Alice's email address (alice@email. com) matches that published in the identity certificate's AddData field. Knowledge of this public identity establishes a verifiable link to the certified identity, where the latter is hidden to avoid disclosing the prover's parent public key pkₚₐᵣ in the certificate's data structure (the message m). Recall that the verifier has knowledge of the checks carried out by the circuit because the verification key is linked to the circuit. The circuit checks the identity in the certificate and uses the certified public key from the certificate to derive the output that is known by the verifier. Therefore, explicit knowledge of the certified parent key is not required. The circuit validates the certificate by verifying the CA's signature using the CA's public key that is included as a public input. If the signature check passes, the circuit parses the certificate for the parent public key and uses this to derive an unhardened child key as an output. If a hardened child key is required, the private parent key skₚₐᵣ 908 must be included as an additional secret input to the circuit. The circuit must then check whether this private key corresponds to the certified public key in the certificate using the ECSM sub-routine to compute its corresponding public key. The child key in the circuit output is accepted once all of these checks have been satisfied. The checks referred to above are integrated into the verification key such that if proof verification passes using the verification key the verifier knows that that these checks have passed.

Consider a scenario whereby a user Bob (verifier) wishes to pay Alice (prover) using only her email address. In this scenario the verifier computer equipment 602a corresponds to Bob's computer equipment 102a. The prover computer equipment 602b may correspond to the computer equipment 102a associated with Alice 103a or a wallet server associated with Alice's BIP32 wallet provider. We refer below to an example whereby the prover computer equipment 602b corresponds to a wallet server associated with Alice's BIP32 wallet provider.

Bob 103b requests Alice's payment address from her wallet server (prover computer equipment 602b) using alice@email. com, and subsequently receives Alice's 103a payment address from her wallet server. At step S602 Bob 103b also obtains the unhardened child public key

$${pk}_{i}^{}$$

or hardened child public key

$${pk}_{i}^{′}$$

916 (either directly from Alice's computer equipment 102a, from Alice's wallet server, or by some other means).

At step S604, Bob 103b requests proof that this public key is authentic before finalising their payment transaction.

At step S606, the wallet server generates a proof based on a valid assignment to the public circuit representing the CKD function. In particular, the wallet server generates a proof π for Bob to verify that he has been provided with a valid child public key linked to Alice's certified key pkₚ, without disclosing the certified parent public key itself.

To generate the proof at step S606, Alice's wallet server (prover computer equipment 602b) supplies the input ‘ [symbol] ’ into a proof generation process which in this example embodiment includes the public inputs to the function F 914 (prover's email address alice@email. com 910, and the issuing CA's public key pk_{CA} 912) and the public output from the function F 914 (the hardened child public keys pk′ᵢ or unhardened child public key pkᵢ 916).

To generate the proof at step S606, Alice's wallet server (prover computer equipment 602b) additionally supplies the input ‘W’ into the proof generation process which includes all secret parameters in the valid assignment e.g., secret inputs to the function F 914 (receiver's signed digital certificate Cert 902, chain code corresponding to parent key cₚₐᵣ 904, index i 906, and the private parent key skₚₐᵣ 908 if hardened key in output) and any secret auxiliary variables.

The prover computer equipment 602b additionally supplies the proving key pk_{F}, as an input into the proof generation process.

The proof generation process implemented by the prover computer equipment 602b uses the inputs ‘ [symbol] ’, ‘W’, and the proving key pk_{F} to generate a proof π.

For simplicity, we refer hereon to only unhardened child keys for this example proof. By verifying the wallet server's proof, Bob is satisfied that the payment address derived from the child public key pkᵢ is correct.

The identity-linked CKD protocol is as follows:
1. Given pkₚₐᵣ and alice@email. com, generate

$$m = ( MetaData ‖ PubKey ‖ AddData )$$

where AddData that includes alice@email.com is public and MetaData, PubKey are secret.
2. Given m and sk_{CA}, generate

$$Cert = ( {Sig}_{{sk}_{CA}} ( m ) , m )$$

where Cert, Sigₛₖ_{_{CA}}(m) are secret.
3. Given (pkₚₐᵣ, cₚₐᵣ), compute pkᵢ satisfying

$${pk}_{i} = {pk}_{par} + HMAC {512}_{L} ( {c}_{par} , {pk}_{par} ‖ i ) \cdot G$$

where pkᵢ is public and pkₚₐᵣ, cₚₐᵣ, i are secret.

The ZKP is constructed as follows:

Given pkᵢ, AddData and pk_{CA}, provide a zkSNARK proof π of a witness w for

$$\{ {pk}_{par} , {c}_{par} , i , Cert , AddData , {pk}_{CA} : ∃ w = ( {w}_{1} , {w}_{2} , {w}_{3} , {w}_{4} ) s . t .$$

$${pk}_{i} = {w}_{1} + HMAC {512}_{L} ( {w}_{2} , {w}_{1} ‖ {w}_{3} ) \cdot G ,$$

$${w}_{4} = ( {Sig}_{{sk}_{CA}} ( {w}_{1} , AddData ) , ( {w}_{1} , AddData ) ) \} .$$

In order to verify the proof, the verifier computer equipment 602a supplies the proof and the input ‘ [symbol] ’ into a proof verification process which in this example embodiment includes the public inputs to the function F 914 (prover's email address alice@email.com 910, and the issuing CA's public key pk_{CA} 912) and the public outputs from the function F (the hardened child public keys pk′ᵢ or unhardened child public key pkᵢ 916).

The verifier computer equipment 602a additionally supplies the verification key Vk_{F}, as an input into the proof verification process.

The proof verification process implemented by the verifier computer equipment 602a uses the proof, input ‘ [symbol] ’ and the verification key vk_{F} to verify the proof π. The proof verification process outputs an accept or reject decision depending on whether the proof is found to be valid or invalid. By verifying Alice's proof at step S610, Bob 103b can be sure that the child public key has been derived correctly using the BIP32 derivation method from the certified parent public key. This assures Bob 103b that the payment address they have for Alice is indeed the correct one.

Whilst this embodiment has been described above with reference to the input ‘W’ used in the proof generation process comprising the parent chain code cₚₐᵣ 904, and the key index i 906, this is merely an example, and one or both of the parent chain code cₚₐᵣ 904 and the key index i 906 may be a public input ‘x’ that is part of the input ‘ [symbol] ’ used in the proof generation and proof verification processes. Each of the parent chain code cₚₐᵣ 904 and the key index i 906 can either be secret or public.

### Obfuscated and Identity-Linked Child Key Derivation Proof

In this embodiment, we describe an alternative protocol for identity-linked CKD proofs that seeks to reduce the computational cost of certification for wallet users while optimising the computational efficiency of the ZKP.

The section above describes the steps that the user (e.g. Alice acting as a prover) follows to certify their parent public key with a CA. This certification process generates a growing computational cost to the user who needs to periodically update their expired identity certificates. In this embodiment, this expense is shifted to the wallet server by introducing an internal service for certificate issuance.

Here, the wallet server of a prover or a third party affiliated with the wallet server of the prover can act as a signing authority (SA) by obtaining certification from a trusted CA.

The SA then uses its CA-certified keypair to certify user keys. The resultant chain of trust between the CA, SA and user enables widescale certification of user keys due to the allocation of signing privileges to the wallet server, who can then offer certification to its users. Note that the verifier needs to validate this chain of trust by:
verifying the CA's signature certifying the SA's identity, and
verifying the SA's signature certifying the user's identity.

In the section described above the user's identity certificate is set as a secret input to the circuit so that the parent public key embedded within the certificate data structure is hidden from the verifier during verification. It is possible to reduce the size of the circuit to optimise the computational efficiency of the ZKP by performing signature verification independently to the verification of the proof. This requires additional steps to ensure that the certified parent key remains hidden from the verifier.

Here, we require that the SA obfuscates the user's parent public key before it is embedded in a certificate. More specifically, the SA generates a hash-based commitment of the parent key, which is then linked to the user's identity in a data structure signed by the SA. The format of this signed data structure differs from a CA-issued identity certificate in that it contains a commitment of the user's parent key rather than the parent public key itself.

A commitment scheme is the following two-phase protocol that takes place between a sender (the committer) and a receiver (the verifier):
I. Commit—The committer knows a secret message m and generates a commitment Commit(m, r) using a random value r. The committed value Commit(m, r) is then sent to the verifier.
II. Opening—The committer reveals the message m and the random value r and the verifier can open the commitment and validate its correctness.

A commitment scheme should satisfy the following two security properties:
hiding—after the commit phase, the commitment should not leak any information e.g., to a malicious verifier about the message m, and
binding—during the opening phase, the committer cannot change the message m e.g., by sending a different randomness r′ that causes the commitment to open a different message m′.

A secure commitment is one in which both hiding and binding properties are satisfied. Commitment schemes might use hash functions or randomised encryption algorithms.

Whilst we refer herein to the use of a hash-based commitment scheme for efficiency purposes, it will be appreciated that other types of commitment scheme may be used.

We define a signing authority (SA) to be a trusted affiliate who acts on behalf of the wallet server to link a parent key with an identity. The SA first derives a hash-based commitment of the prover's parent key, which is then linked to their identity data in a signed data structure that resembles a digital certificate (also referred to herein as a second identify certificate. This signed data structure issued by the SA contains a hash-based commitment of the user's parent public key instead of the raw parent public key that is normally included in a digital certificate.

Here we assume the SA's identity has been verified prior to setup (following the same steps as the prover in the section described above) where a CA issues a digital certificate to certify the SA's digital keypair. Note that all computations during setup are carried out offline to protect the SA's private key sk_{SA} and decrease its attack surface.
I. Parent Key Obfuscation: The SA obfuscates the prover's public parent key pkₚₐᵣ

$$( or {pk}_{par}^{′} )$$

by deriving a hash-based commitment as follows:

$$com = Commit ( {pk}_{par} , r ) = H ( {pk}_{par} ‖ r )$$

$$where H ( {pk}_{par} ‖ r ) = SHA 256 ( {pk}_{par} ‖ r ) and r {∈}_{R} {\{ 0 , 1 \}}^{225} .$$

II. Signature Generation: The SA authorises the prover's identity by creating a signature of the hash of a message m_{com} as follows:

$$SignID = ( {Sig}_{{sk}_{SA}} ( {m}_{com} ) , {m}_{com} )$$

where m_{com}=(com∥alias@nchain. com) contains the obfuscated parent public key and identity-related information in the form of an alias, and sk_{SA} is the private key used to generate the SA's signature on the message m_{com}. The SA can also add a timestamp to the signature to ensure that the resultant child keys have a lifetime.

The obfuscation of the public key in step I above ensures that user privacy is preserved. The full extended parent key could also be obfuscated by concatenating the public parent key and chain code (pkₚₐᵣ∥cₚₐᵣ) before creating the commitment. Alternatively, two separate commitments for the public key and chain code (com₁, com₂) could be computed using two distinct random values r₁, r₂ ∈R {0,1}²²⁵ respectively. It is worth noting that each user request for a CKD proof using this protocol generates a distinct commitment com due to the distinct random number r that is contained within the commitment.

In this embodiment, the signed commitment of the parent public key is used to generate the ZKP.

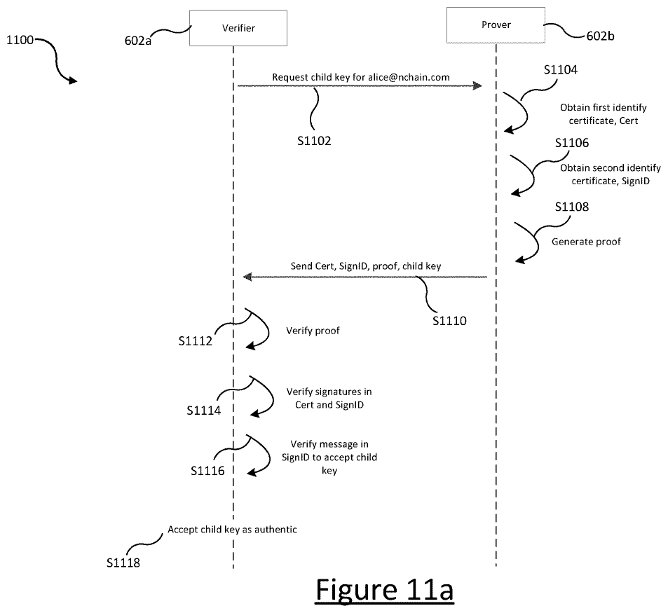

A circuit, C, that is illustrated in FIG. 10 represents the BIP32 CKD function for either hardened child public keys pk′ᵢ or unhardened child public keys pkᵢ and for which knowledge of the function's inputs given one or more known outputs will be proved.

FIG. 10 is used to show which inputs/outputs are public/secret in the proof generation/verification process.

The circuit, C, is based on the following assumptions:
The extended public parent key (pkₚₐᵣ, cₚₐᵣ) is not known.
The alias of the receiver is known.
The BIP32 CKD method is known such that (pkᵢ, cᵢ)←CKD_{pub}((pkₚₐᵣ, Cₚₐᵣ), i)) is the i^{th} unhardened child key and

$$( {pk}_{i}^{′} , {c}_{i} ) ← {CKD}_{pub} ( ( s {k}_{par} , {c}_{p a r} ) , i ) )$$

is the i^{th} hardened child key.
The elliptic curve generator point G is hardcoded for both prover and verifier.

The inputs to the circuit are:
Secret input \vec{w}
Private parent key skₚₐᵣ 1002
Chain code 1004 corresponding to the parent key cₚₐᵣ
Index i 1006
Random value r 1008
Public input \vec{x}
   Prover's alias alias@nchain. com (i.e. a unique identifier of the prover)1010

and the outputs are:
Child public key pkᵢ or

$${pk}_{i}^{′}$$

1014
Message m_{com} 1016

The parent public key may be unhardened or hardened

$$( {pk}_{p a r}^{′} ) ;$$

the notation Pkₚₐᵣ is used here for simplicity.

The prover computer equipment 602b executes the circuit, C, to output a valid assignment. That is, the prover computer equipment 602b supplies the inputs referred above to the circuit, C, to generate the outputs referred to above.

A valid assignment ( [symbol] ,W) to the circuit comprises 5 inputs (Skₚₐᵣ, Cₚₐᵣ, i,r,alias@nchain.com), 2 outputs (out₁,m_{com}), and auxiliary variables which include pkₚₐᵣ, ▪∥ i, I_{L}, (I_{L}·G), com}where

$$◼ = {sk}_{par} for {out}_{1} ≡ {pk}_{i}^{′} or ◼ = {pk}_{par} for {out}_{1} ≡ {pk}_{i} .$$

FIG. 10 illustrates whether the inputs are public or secret (denoted by a shaded box), and the computation occurring within the function F 1012 that produces the specified outputs. The auxiliary variables generated during execution of the function F 1012 are not explicitly shown in FIG. 10.

At a high-level, the computational steps in the circuit for this valid assignment are as follows:
Step 1. Set secret (in₂, in₃, in₄, in₅) and public (in₅) inputs as:

$$i {n}_{1} = s {k}_{p a r} , i {n}_{2} = {c}_{p a r} , i {n}_{3} = i , i {n}_{4} = r , {in}_{5} = alias @ nchain . com .$$

Step 2. Execute function F 1012 using given inputs:
   i. Compute aux₁=ECSM(in₁)
   ii. If 0≤in₃<2³¹:
      a. Compute aux₂=(aux₁∥in₃)
   Elseif 2³¹≤in₃<2³²:
      b. Compute aux₂=(in₁∥in₃)
   Else:
      c. Fail.
iii. Compute aux₃=HMAC512_{L}(in₂, aux₂)
iv. Compute aux₄=ECSM(aux₃)
v. Compute out₁=aux₁+aux₄:
   If in₃<2³¹:
      a. out₁≡pkᵢ
   Else:
      b.

$${out}_{1} ≡ {pk}_{i}^{′}$$

vi. Compute aux₅=H(aux₁∥in₄)
   vii. Compute out₂=(aux₅∥in₅)
Step 3. Publish output of function F:
   out₁=pkᵢ or

$${pk}_{i}^{′} ,$$

out₂=m_{com}.

Whilst FIG. 10 illustrates the private key skₚₐᵣ being set as an input, the public parent key pkₚₐᵣ can instead be set as an input, although this limits the output to unhardened child keys only (step 2i is not necessary).

If an extended child public key is desired in the output (output includes chain code cᵢ), the chain code cᵢ can be computed by replicating step 2iii for the rightmost output I_{R} of the HMAC function.

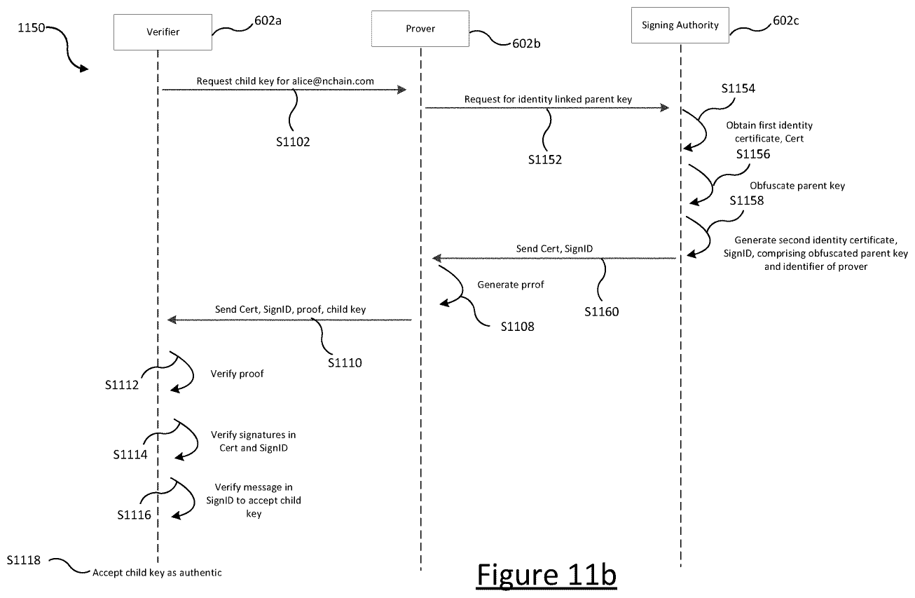

FIG. 11a illustrates the steps performed by a verifier computer equipment 602a and a prover computer equipment 602b in a process 600 for verifying the authenticity of a child public key.

Consider a scenario whereby a user Bob (verifier) who would like to send Alice (prover) a payment using her alias, alice@nchain. com. In this scenario the verifier computer equipment 602a corresponds to Bob's computer equipment 102b. We refer below to an example whereby the prover computer equipment 602b corresponds to a wallet server associated with Alice's BIP32 wallet provider. In a variant of this, the prover computer equipment 602b may correspond to Alice's computer equipment 102a.

At step S1102, the verifier computer equipment 602a associated with the verifier Bob submits a request to Alice's wallet server (prover computer equipment 602b) for a payment address linked to alice@nchain. com (an email address or any other unique identifier associated with the prover).

At step S1104, Alice's wallet server (prover computer equipment 602b) obtains a first digital certificate Cert (issued by a CA). The first digital certificate Cert comprises a signature of the CA.

At step S1106, Alice's wallet server (prover computer equipment 602b) obtains a second digital certificate which is Alice's signed commitment and alias SignID (issued by the SA), which contains her publicly known identity data (alice@nchain. com) and obfuscated parent key, com.

In some embodiments, the wallet server (prover computer equipment 602b) can act as the signing authority (SA) by obtaining certification from a trusted CA. In these embodiments, the wallet server performs steps S1104 and S1106 without involvement of a remote signing authority device.

In other embodiments, the wallet server performs steps S1104 and S1106 by communicating with a remote signing authority device 602c. This is illustrated in FIG. 11b where the wallet server transmits a request for an identity linked parent key to a remote signing authority device 602c at step S1152. At step S1154 the remote signing authority device 602c obtains the first digital certificate Cert. At step S1156 the remote signing authority device 602c performs the parent public key obfuscation described above, and generates the second digital certificate SignID at step S1158. The steps S1156 and S1158 are preferably performed by the remote signing authority device 602c whilst it is offline (no internet access) for security reasons to protect the SA's private key sk_{SA} and decrease its attack surface.

Thus acting on behalf of the wallet server, the remote signing authority device 602c enacts the identity-linked CKD protocol as follows:
1. Given pkₚₐᵣ, generate

$$com = Commit ( {pk}_{p a r} , r ) = SHA 256 ( p {k}_{p a r} ‖ r )$$

where com is public and pkₚₐᵣ,r are secret.
2. Given com, alice@nchain. com, generate

$${m}_{com} = ( com ‖ alice @ nchain . com )$$

where m, alice@nchain. comare public.
3. Given m and sk_{SA}, generate

$$SignID = ( S i {g}_{s {k}_{S A}} ( {m}_{c o m} ) , {m}_{c o m} )$$

where SignID is public.

At step S1160 the remote signing authority device 602c transmits the first digital certificate Cert and the second digital certificate SignID to the wallet server (prover computer equipment 602b)

At step S1108, the wallet server (prover computer equipment 602b) generates a proof based on a valid assignment to the public circuit representing the CKD function.

To generate the proof at step S1108, the prover computer equipment 602b supplies the input ‘ [symbol] ’ into a proof generation process which in this example embodiment includes the public inputs to the function F 1012 (the unique identifier of the prover alice@nchain.com 1010) and the public outputs from the function F 1012 (the unhardened, pkᵢ or hardened,

$${pk}_{i}^{′}$$

child public key 1014; and the Message m_{com} 1016).

The child public key 1014 may be computed by the wallet server (prover computer equipment 602b). Alternatively, in the example of FIG. 11b, the child public key 1014 may be computed by the remote signing authority device 602c and supplied to the wallet server at step S1160

In the example of unhardened public parent and child keys in the example proof, this child public key computation comprises:
Given (pkₚₐᵣ, cₚₐᵣ), compute pkᵢ satisfying

$$p {k}_{i} = p {k}_{p a r} + HMAC {512}_{L} ( {c}_{p a r} , {pk}_{p a r} ‖ i ) \cdot G$$

where pkᵢ is public and pkₚₐᵣ, cₚₐᵣ, i are secret

This proof proves that a given child key pkᵢ is generated from the signed and obfuscated parent key in SignID.

To generate the proof at step S1108, the prover computer equipment 602b additionally supplies the input ‘W’ into the proof generation process which includes all secret parameters in the valid assignment e.g., secret inputs to the function F 1012 (the private parent key skₚₐᵣ 1002, chain code 1004 corresponding to the parent key cₚₐᵣ, the index i 1006, and the random value r 1008) and any secret auxiliary variables.

The prover computer equipment 602b additionally supplies the proving key pk_{F}, as an input into the proof generation process.

In the example of unhardened public parent and child keys in the example proof, the wallet server constructs the ZKP as follows:
1. Given pkᵢ and alice@nchain. com, provide a zkSNARK proof π of a witness w for

$$\{ {pk}_{par} , {c}_{par} , i , r , alice @ nchain . com : ∃ w = ( {w}_{1} , {w}_{2} , {w}_{3} , {w}_{4} ) s . t .$$

$${pk}_{i} = {w}_{1} + HMAC {512}_{L} ( {w}_{2} , {w}_{1} ‖ {w}_{3} ) \cdot G ,$$

$${m}_{com} = ( SHA 256 ( {w}_{1} ‖ {w}_{4} ) ‖ alice @ nchain . com ) \} .$$

The proof generation process implemented by the wallet server uses the inputs ‘ [symbol] ’,‘W’ and the proving key pk_{F} to generate a proof π. Alice's proof shows that the public key that will be sent to Bob is indeed the child of her certified parent key.

At step S1110, the wallet server (prover computer equipment 602b) transmits the first digital certificate Cert, the second digital certificate SignID, the proof Tn, and the child key for alice@nchain. com to the verifier computer equipment 602a.

In this embodiment, determining the authenticity of the child public key comprises multiple steps.

At step S1112 the verifier computer equipment 602a verifies the proof π. In order to verify the proof, the verifier computer equipment 602a supplies the proof and the input ‘ [symbol] X’ into a proof verification process which in this example embodiment includes the public inputs to the function F 1012 (the unique identifier of the prover alice@nchain.com 1010) and the public outputs from the function F 1012 (the unhardened, pkᵢ or hardened,

$${pk}_{i}^{′}$$

child public key 1014; and the Message m_{com} 1016).

The verifier computer equipment 602a additionally supplies the verification key vk_{F}, as an input into the proof verification process.

The proof verification process implemented by the verifier computer equipment 602a uses the proof, input ‘ [symbol] ’ and the verification key vk_{F} to verify the proof π. The proof verification process outputs an accept or reject decision depending on whether the proof is found to be valid or invalid.

By verifying the proof for pkᵢ, Bob verifies its authenticity as the child of the identity-linked parent key in the commitment within the second output m_{com}.

At step S1114, the integrity of the obfuscated version of the parent key in the second digital certificate SignID is verified by: (i) verifying the signature of the CA of the first digital certificate Cert (using a public key of the CA), and verifying the signature of the SA of the second digital certificate SignID (using a public key of the SA). Verifying the signatures in the SA's identity certificate and Alice's signed commitment establishes the chain of trust between the CA, SA and Alice; Bob can therefore be satisfied with the integrity of the obfuscated parent key in SignID.

This entails the following:

$$1. Given Cert = ( {Sig}_{{sk}_{CA}} ( {m}_{SA} ) , {m}_{SA} ) and {pk}_{CA} , compute$$

$$SigVerify ( Cert , {pk}_{CA} ) .$$

$$2. Given SignID = ( {Sig}_{{sk}_{SA}} ( {m}_{com} ) , {m}_{com} ) , {pk}_{SA} and π , compute$$

$$SigVerify ( SignID , {pk}_{SA} ) ,$$

At step S1116, the verifier computer equipment 602a verifies the message m_{com} that is received in the second digital certificate SignID.

In particular, the verifier computer equipment 602a obtains the message m_{com} 1016 used by the proving computer device to generate the proof. For example the verifier computer equipment 602a may receive the message m_{com} 1016 (used by the proving computer device to generate the proof) from the proving computer device. The verifier computer equipment 602a verifies that that the message m_{com} 1016 used by the proving computer device to generate the proof matches the message m_{com} that is received in the second digital certificate SignID.

Once these three verification steps have passed successfully at step 1118 the verifier accepts the child public key as authentic. Bob 103b can then proceed to send a transaction to a payment address derived from the child key.

Whilst this embodiment has been described above with reference to the input ‘W’ used in the proof generation process comprising the parent chain code cₚₐᵣ 1004, and the key index i 1006, this is merely an example, and one or both of the parent chain code cₚₐᵣ 1004 and the key index i 1006 may be a public input ‘x’ that is part of the input ‘X’ used in the proof generation and proof verification processes. Each of the parent chain code cₚₐᵣ 1004 and the key index 1006 can either be secret or public.

### CONCLUSION

Other variants or use cases of the disclosed techniques may become apparent to the person skilled in the art once given the disclosure herein. The scope of the disclosure is not limited by the described embodiments but only by the accompanying claims.

For instance, whilst some embodiments above have been described with reference to a unique identifier of a prover being the prover's email address, this is just one example and other unique identifiers (e.g. a telephone number or other contact details, social security number, ID number etc.) may be used.

Persons skilled in the art will appreciate that the steps involved in the proof generation process implemented by the proving computer device using the inputs ‘ [symbol] ’, ‘W’ and the proving key pk_{F} to generate a proof T will depend on the particular type of ZKP being implemented and such steps are known to persons skilled in the art. Similarly, persons skilled in the art will appreciate that the steps involved in the proof verification process implemented by the verifier computer equipment using the proof, input ‘ [symbol] ’ and the verification key vk_{F} to verify the proof i, will depend on the particular type of ZKP being implemented and such steps are known to persons skilled in the art.

Embodiments have been described above in the context of a verifier sending a payment to a prover and the proof proving that a payment address derived from the child public key is authentic, however embodiments of the present invention are not limited to this payment context and embodiments extends to any application where a digital key (representing an online identity) is used e.g. in data transactions, smart contracts etc.

Whilst embodiments have been described above with reference to the BIP32 key derivation protocol, embodiments extend to other key derivation protocols.

Some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Aspects of the present disclosure are defined below with reference to the following clauses:
1. A computer implemented method of verifying the authenticity of a child public key that is associated with an entity, the method performed on a computing device and comprising:
   obtaining the child public key;
   receiving a zero knowledge proof from a proving computing device, the proving computing device may be associated with said entity;
   verifying that the zero knowledge proof is valid using the proof, the child public key, and a verification key to determine that a key derivation protocol has been used to derive the child public key from a parent key; and determining the authenticity of the child public key based on said verifying.
2. The computer implemented method of clause 1, wherein obtaining the child public key comprises receiving the child public key from the proving computing device.
3. The computer implemented method of clause 1 or 2, wherein the method comprises:
   transmitting a request to the proving computer device for a proof that the child public key is authentic;
   wherein the zero knowledge proof is received in response to the request.
4. The computer implemented method of any preceding clause, wherein the parent key is a private parent key and the child public key is a hardened child public key.
5. The computer implemented method of any of clauses 1 to 3, wherein the parent key is a parent public key.
6. The computer implemented method of clause 4, further comprising:
   obtaining a copy of a parent public key corresponding to the private parent key; and verifying that the zero knowledge proof is valid additionally uses the parent public key.
7. The computer implemented method of clause 6, further comprising:
   receiving, from the proving computer device, a parent public key used by the proving computer device to generate the proof; and
   determining the authenticity of the child public key is further based on if the parent public key used by the proving computer device to generate the proof matches the obtained copy of the parent public key.
8. The computer implemented method of clause 6, wherein the parent key is a certified parent public key of a signed digital certificate issued by a certificate authority.
9. The computer implemented method of clause 8, wherein the signed digital certificate includes a unique identifier of the entity, and verifying that the zero knowledge proof is valid comprises checking that a public unique identifier of the entity matches the unique identifier of the entity in the signed digital certificate.
10. The computer implemented method of clause 8 or 9, wherein the signed digital certificate is signed using a private key of the certificate authority and verifying that the zero knowledge proof is valid comprises verifying a signature of the certificate authority using a public key of the certificate authority.
11. The computer implemented method of any of clauses 1 to 5, wherein the method comprises:
   receiving a first identity certificate associated with a signing authority, the first identity certificate comprising a first signature of a certificate authority;
   receiving a second identify certificate associated with the entity, the second identify certificate comprising a second signature of a signing authority and a message, the message comprising an obfuscated version of the parent key and a unique identifier of the entity; and
   verifying that the zero knowledge proof is valid additionally uses the message.
12. The computer implemented method of clause 11, wherein determining the authenticity of the child public key is further based on:
   verifying the integrity of the obfuscated version of the parent key in the second identify certificate by verifying the first signature using a public key of the certificate authority and verifying the second signature using a public key of the signing authority.
13. The computer implemented method of clause 11 or 12, further comprising:
   obtaining a message used by the proving computer device to generate the proof; and
   determining the authenticity of the child public key is further based on verifying that the message used by the proving computer device to generate the proof matches the message in the second identify certificate.
14. The computer implemented method of any of clauses 11 to 13, wherein the method comprises:
   transmitting a request to the proving computer device, the request requesting the child public key; and
   in response to the request, receiving the child public key, the zero knowledge proof, the first identity certificate and the second identity certificate.
15. A computer implemented method of providing proof of the authenticity of a child public key that is associated with an entity, the method performed on a computing device and comprising:
   generating a zero knowledge proof using a parent key used to derive the child public key, the child public key, and a proving key; and
   transmitting the zero knowledge proof to a verifying computing device to enable the verifying computing device to prove that a key derivation protocol has been used to derive the child public key from the parent key.
16. The computer implemented method of clause 15, wherein the parent key was generated using a first portion of a hash function output and the method comprises generating the zero knowledge proof using a remaining portion of the hash function output.
17. The computer implemented method of clause 15 or 16, wherein the method comprises generating the zero knowledge proof using a key index indicating whether the child public key is hardened or unhardened.
18. The computer implemented method of any of clauses 15 to 17, wherein the parent key is a parent private key that is not exposed to the verifying computing device, and the child public key is a hardened child public key.
19. The computer implemented method of any of clauses 15 to 17, wherein the parent key is a parent public key.
20. The computer implemented method of clause 19, wherein the method comprises
   generating the zero knowledge proof additionally using (i) a signed digital certificate wherein the signed digital certificate comprises the parent public key and a publicly known unique identifier of the entity, wherein the signed digital certificate is signed by a certificate authority and is not exposed to the verifying computing device; (ii) the unique identifier of the entity; and (iii) a public key associated with the certificate authority.
21. The computer implemented method of clause 20, wherein the method comprises generating the zero knowledge proof additionally using (iv) a parent private key corresponding to the parent public key, wherein the child public key is a hardened child public key.
22. The computer implemented method of clause 19 or 20, the child public key is an unhardened child public key.
23. The computer implemented method of any of clauses 15 to 18, wherein the method comprises:
   obtaining a first identity certificate associated with a signing authority, the first identity certificate comprising a first signature of a certificate authority; and
   obtaining a second identify certificate associated with an entity, the second identify certificate comprising a second signature of a signing authority and a message, the message comprising an obfuscated version of the parent key and a unique identifier of the entity;
   wherein the method comprises generating the zero knowledge proof additionally using a random value used to generate the obfuscated version of the parent key, and the unique identifier of the entity associated with the computing device, and the method further comprising:
   transmitting the first identity certificate and the second identify certificate to the verifying computing device.
24. The computer implemented method of clause 23, wherein the computing device acts as the signing authority and obtaining the second identify certificate comprises:
   obfuscating the parent key using the random value to generate the obfuscated version of the parent key;
   generating the second identify certificate by signing a message, comprising the obfuscated version of the parent key and the identifier of the entity, using a private key associated with the signing authority.
25. The computer implemented method of clause 23 or 24, wherein obtaining the first identify certificate and the second identify certificate comprises receiving the first identify certificate and the second identify certificate from a remote computing device associated with the signing authority.
26. The computer implemented method of any of clauses 23 to 25, wherein the method comprises transmitting the child public key to the verifying computing device.
27. The computer implemented method of any of clauses 15 to 18, wherein the method comprises transmitting a parent public key, corresponding to the parent private key to the verifying computing device.
28. The computer implemented method of any preceding clause, wherein the key derivation protocol comprises a hash function that takes the parent key as an input.
29. The computer implemented method of any preceding clause, wherein the key derivation protocol is BIP32.
30. A computer program that, when read by a computing device, causes the computing device to perform the method of any preceding clause.
31. A non-transitory computer readable storage medium comprising computer readable instructions that, when read by a computing device, cause the computing device to perform the method of any of clauses 1 to 29.
32. A computing device comprising a processor and memory, the memory storing instructions which, when executed by the processor cause the computing device to perform the method of any of clauses 1 to 29.

The instructions may be provided on a carrier such as a disk, CD- or DVD-ROM, programmed memory such as read-only memory (Firmware), or on a data carrier such as an optical or electrical signal carrier. The instructions to implement embodiments of the present disclosure may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language.

1. A computer implemented method of verifying an authenticity of a child public key that is associated with an entity, the method performed on a computing device and comprising:
obtaining the child public key;
receiving a zero knowledge proof from a proving computing device;
verifying that the zero knowledge proof is valid using the proof, the child public key, and a verification key, to determine that a key derivation protocol has been used to derive the child public key from a parent key; and
determining the authenticity of the child public key based on said verifying.

2. The computer implemented method of claim 1, wherein obtaining the child public key comprises receiving the child public key from the proving computing device.

3. The computer implemented method of claim 1, wherein the method comprises:
transmitting a request to the proving computer device for a proof that the child public key is authentic;
wherein the zero knowledge proof is received in response to the request.

4. The computer implemented method of claim 1, wherein the parent key is a private parent key and the child public key is a hardened child public key.

5. The computer implemented method of claim 1, wherein the parent key is a parent public key.

6. The computer implemented method of claim 4, further comprising:
obtaining a copy of a parent public key corresponding to the private parent key; and verifying that the zero knowledge proof is valid additionally uses the parent public key.

7. The computer implemented method of claim 6, further comprising:
receiving, from the proving computer device, a parent public key used by the proving computer device to generate the proof; and
determining the authenticity of the child public key is further based on if the parent public key used by the proving computer device to generate the proof matches the obtained copy of the parent public key.

8. The computer implemented method of claim 6, wherein the parent key is a certified parent public key of a signed digital certificate issued by a certificate authority.

9. The computer implemented method of claim 8, wherein the signed digital certificate includes a unique identifier of the entity, and verifying that the zero knowledge proof is valid comprises checking that a public unique identifier of the entity matches the unique identifier of the entity in the signed digital certificate.

10. The computer implemented method of claim 8, wherein the signed digital certificate is signed using a private key of the certificate authority and verifying that the zero knowledge proof is valid comprises verifying a signature of the certificate authority using a public key of the certificate authority.

11. The computer implemented method of claim 1, wherein the method comprises:
receiving a first identity certificate associated with a signing authority, the first identity certificate comprising a first signature of a certificate authority;
receiving a second identify certificate associated with the entity, the second identify certificate comprising a second signature of a signing authority and a message, the message comprising an obfuscated version of the parent key and a unique identifier of the entity; and
verifying that the zero knowledge proof is valid additionally uses the message.

12. The computer implemented method of claim 11, wherein determining the authenticity of the child public key is further based on:
verifying an integrity of the obfuscated version of the parent key in the second identify certificate by verifying the first signature using a public key of the certificate authority and verifying the second signature using a public key of the signing authority.

13. The computer implemented method of claim 11, further comprising:
obtaining a message used by the proving computer device to generate the proof, and
determining the authenticity of the child public key is further based on verifying that the message used by the proving computer device to generate the proof matches the message in the second identify certificate.

14. The computer implemented method of claim 11, wherein the method comprises:
transmitting a request to the proving computer device, the request requesting the child public key; and
in response to the request, receiving the child public key, the zero knowledge proof, the first identity certificate and the second identity certificate.

15. A computer implemented method of providing proof of an authenticity of a child public key that is associated with an entity, the method performed on a computing device and comprising:
generating a zero knowledge proof using a parent key used to derive the child public key, the child public key, and a proving key; and
transmitting the zero knowledge proof to a verifying computing device to enable the verifying computing device to prove that a key derivation protocol has been used to derive the child public key from the parent key.

16. The computer implemented method of claim 15, wherein the parent key was generated using a first portion of a hash function output and the method comprises generating the zero knowledge proof using a remaining portion of the hash function output.

17. (canceled)

18. The computer implemented method of claim 15, wherein the parent key is a parent private key that is not exposed to the verifying computing device, and the child public key is a hardened child public key.

19. The computer implemented method of claim 15, wherein the parent key is a parent public key.

20-30. (canceled)

31. A non-transitory computer readable storage medium comprising computer readable instructions that, when executed by a computing device, cause the computing device to perform a method of verifying an authenticity of a child public key that is associated with an entity, the method performed on a computing device and comprising:
obtaining the child public key:
receiving a zero knowledge proof from a proving computing device:
verifying that the zero knowledge proof is valid using the proof, the child public key, and a verification key, to determine that a key derivation protocol has been used to derive the child public key from a parent key; and
determining the authenticity of the child public key based on said verifying.

32. A computing device comprising a processor and memory, the memory storing instructions which, when executed by the processor, cause the computing device to perform a method of verifying an authenticity of a child public key that is associated with an entity, the method performed on a computing device and comprising:
obtaining the child public key;
receiving a zero knowledge proof from a proving computing device;
verifying that the zero knowledge proof is valid using the proof, the child public key, and a verification key, to determine that a key derivation protocol has been used to derive the child public key from a parent key; and
determining the authenticity of the child public key based on said verifying.
